(19) United States
(12) Patent Application Publication
(10) Pub. No.: US 2023/0350169 A1
(43) Pub. Date: Nov. 2, 2023

(54) THERMAL RADIATION LENS

(71) Applicant: National University Corporation Tokyo University of Agriculture and Technology, Tokyo (JP)

(72) Inventor: Takehito SUZUKI, Tokyo (JP)

(73) Assignees: National University Corporation Tokyo University of Agriculture and Technology, Tokyo (JP); National University Corporation Tokyo University of Agriculture and Technology, Tokyo (JP)

(21) Appl. No.: 17/639,339

(22) PCT Filed: Aug. 31, 2020
(86) PCT No.: PCT/JP2020/032967

§ 371 Date: Mar. 1, 2022

(30) Foreign Application Priority Data
Sep. 2, 2019 (JP) 2019-159868

(51) Int. Cl. G02B 13/14

(52) U.S. Cl. CPC G02B 13/14; G02B 1/002

(57) ABSTRACT

A thermal radiation lens is configured to control propagation of thermal radiation, by using a sheet-type material 10 which realizes high refractive-index, non-reflective, and non-polarizing optical properties for a frequency band of a thermal radiation region. The sheet-type material 10 according to the present embodiment includes a substrate 11, a first pattern array 12 arranged regularly in the X-axis direction and the Y-axis direction on one surface of the substrate 11, and a second pattern array 13 formed on the back surface of the substrate relative to the one surface to overlap with the first pattern array, wherein meta-atoms 12a, 13a included in first and second pattern arrays have the same shape and have a width in the X-axis direction and a width in the Y-axis direction which are equivalent to each other within a range of a half wavelength of the thermal radiation.

### BACKGROUND

### 1. Technical Field

The present invention relates to a thermal radiation lens configured to control the propagation of thermal radiation.

### 2. Related Art

Recently, advances in lithographic technologies have enabled sub-wavelength-sized metal structures, which are so-called meta-atoms, to be easily produced, and attention has been paid to an artificial material that is so-called a metamaterial, which has optical properties, for an electromagnetic wave including light, that a natural material does not have. Particularly, research and development of a metasurface which is an artificial surface configured to control a reflection of an electromagnetic wave incident on a surface is advancing.

The refractive index of a material and the reflection and transmission of an electromagnetic wave on a surface depends on the dielectricity and magnetism of the material. Therefore, it is expected that a high refractive-index, non-reflective, and non-polarizing material can be realized by controlling the magnetism as well as the dielectricity by a metasurface. In Non-Patent Document 1, although a super high refractive index material having a refractive index of 22.5 for an electromagnetic wave of frequency 0.5 THz has been realized, the reflectivity is 65%. In Non-Patent Document 2, although a super high refractive index material having a refractive index of 14.4 for an electromagnetic wave of frequency 0.32 THz has been realized, the reflectivity is 90% or more. Meanwhile, in Non-Patent Document 3, a super high refractive index and non-reflective material having a refractive index of 12+j0.92, a reflectivity of 5.1%, a transmittance of 73% in a frequency band of 0.3 THz has been realized. It is expected that such a metasurface is utilized for high-speed wireless communications and imaging technologies utilizing terahertz waves.
Patent Document 1: Japanese Patent Application Publication No. 2017-34584
Non-Patent Document 1: M. Choi et al., Nature 470(7334), 369-373 (2011).
Non-Patent Document 2: S. Tan et al., Opt. Express 23(22), 29222-29230 (2010).
Non-Patent Document 3: Takehito SUZUKI, “exploration of materials with unprecedented refractive indices and the applications to terahertz wave bands,” Appl. Phys, vol. 86, no. 10, pp. 897-902, Oct. 2017.
Non-Patent Document 4: Y. Guo and S. Fan, Opt. Express 24(26), 29896-29907 (2016).

### Technical Problem

Recently attention has further been paid to the control of thermal radiation using a metasurface (for example, see Non-Patent Document 4). Here, a frequency band of thermal radiation depends on the temperature of a heat source; for example, 500 THz band of approximately 8 THz to 200 THz and 200 THz band of approximately 5 THz to 1000 THz are included respectively for a heat source (the typical temperature is 500K) and a steelmaking slag (the typical temperature is 2000K) possible to be provided in a common laboratory. In addition, the polarization of thermal radiation is random. Thus, in these frequency bands, a high refractive-index, non-reflective, and non-polarizing material is desired to be realized.

However, an imaginary component of the conductivity of a metal that can be ignored in a terahertz band cannot be ignored in the frequency band of the thermal radiation, and merely scaling the above-described metasurface to a high-frequency band does not enable obtaining desired properties. In addition, the above-described metasurface does not realize non-polarizing properties.

### GENERAL DISCLOSURE

(Item 1)

A thermal radiation lens configured to control propagation of thermal radiation may include a substrate. The thermal radiation lens may include a plurality of first patterns arranged, on one surface of the substrate, regularly in a first direction parallel to the one surface and in a second direction crossing the first direction. The thermal radiation lens may include a plurality of second patterns formed on a back surface, relative to the one surface, of the substrate to overlap with the plurality of first patterns. The plurality of first patterns and the plurality of second patterns may have a same shape and have a width in the first direction and a width in the second direction equivalent to each other within a range of a half wavelength of the thermal radiation.

(Item 2)

At least a portion of the plurality of first patterns and the plurality of second patterns may be arranged with a gap interposed therebetween in the first direction and in the second direction.

(Item 3)

The plurality of first patterns and the plurality of second patterns may have a circular shape, a square shape, or a cross shape.

(Item 4)

The plurality of first patterns and the plurality of second patterns may have a circular shape, and for a frequency 200 THz of the thermal radiation, a radius of the circular shape may be from 120 nm to 145 nm, and the gap may be from 10 nm to 60 nm, and for a frequency 50 THz of the thermal radiation, a radius of the circular shape may be from 0.5 μm to 1.3 μm, and the gap is from 0.1 μm to 1.1 μm.

(Item 5)

The plurality of first patterns and the plurality of second patterns may have a square shape, and for a frequency 200 THz of the thermal radiation, one side of the square shape is from 260 nm to 335 nm, and the gap is from 50 nm to 150 nm, and for a frequency 50 THz of the thermal radiation, one side of the square shape is from 1.6 nm to 2.0 μm, and the gap is from 0.1 nm to 0.5 μm.

(Item 6)

Another portion of the plurality of first patterns and the plurality of second patterns may be arranged adjacent to the at least the portion of the plurality of first patterns and the plurality of second patterns and arranged, in at least one of the first direction and the second direction, with another gap larger than the gap, interposed therebetween.

(Item 7)

Another portion of the plurality of first patterns and the plurality of second patterns may be disposed adjacent to the at least the portion of the plurality of first patterns and the plurality of second patterns and may have another width different from the width for at least one of the first direction and the second direction.

(Item 8)

The plurality of first patterns and the plurality of second patterns may be arranged periodically in at least one axis direction parallel to the one surface.

(Item 9)

The substrate may be a heat-tolerant dielectric film, and the plurality of first patterns and the plurality of second patterns may be conductive metal films.

(Item 10)

the substrate may be formed of benzocyclobutene (BCB), polyimide, a quartz glass (SiO₂), or silicon nitride (Si₃N₄).

The summary clause does not necessarily describe all necessary features of the embodiments of the present invention. The present invention may also be a sub-combination of the features described above.

### BRIEF DESCRIPTION OF THE DRAWINGS

FIG. 1 shows a configuration of a sheet-type material according to the present embodiment.

FIG. 2A shows an analysis result of an optical property (a real component of an effective refractive index) of the sheet-type material for a designed frequency of 50 THz.

FIG. 2B shows an analysis result of an optical property (transmitted power) of the sheet-type material for the designed frequency of 50 THz.

FIG. 2C shows an analysis result of an optical property (reflected power) of the sheet-type material for the designed frequency of 50 THz.

FIG. 2D shows an analysis result of an optical property (a real component of a relative permittivity) of the sheet-type material for the designed frequency of 50 THz.

FIG. 2E shows an analysis result of an optical property (a real component of a relative permeability) of the sheet-type material for the designed frequency of 50 THz.

FIG. 2F shows an analysis result of an optical property (a phase lag) of the sheet-type material for the designed frequency of 50 THz.

FIG. 3A shows an analysis result of a frequency response property of an optical property (an effective refractive index) of the sheet-type material having pattern arrays optimally configured for the designed frequency of 50 THz.

FIG. 3B shows an analysis result of a frequency response property of an optical property (reflected power and transmitted power) of the sheet-type material having the pattern arrays optimally configured for the designed frequency of 50 THz.

FIG. 3C shows an analysis result of a frequency response property of an optical property (a relative impedance) of the sheet-type material having the pattern arrays optimally configured for the designed frequency of 50 THz.

FIG. 3D shows an analysis result of a frequency response property of an optical property (a relative permittivity) of the sheet-type material having the pattern arrays optimally configured for the designed frequency of 50 THz.

FIG. 3E shows an analysis result of a frequency response property of an optical property (a relative permeability) of the sheet-type material having the pattern arrays optimally configured for the designed frequency of 50 THz.

FIG. 3F shows an analysis result of a frequency response property of an optical property (a phase lag) of the sheet-type material having the pattern arrays optimally configured for the designed frequency of 50 THz.

FIG. 4A shows an analysis result of a an optical property (a real component of an effective refractive index) of the sheet-type material for a designed frequency of 200 THz.

FIG. 4B shows an analysis result of a an optical property (transmitted power) of the sheet-type material for the designed frequency of 200 THz.

FIG. 4C shows an analysis result of an optical property (reflected power) of the sheet-type material for the designed frequency of 200 THz.

FIG. 4D shows an analysis result of an optical property (a real component of a relative permittivity) of the sheet-type material for the designed frequency of 200 THz.

FIG. 4E shows an analysis result of an optical property (a real component of a relative permeability) of the sheet-type material for the designed frequency of 200 THz.

FIG. 4F shows an analysis result of an optical property (a phase lag) of the sheet-type material for the designed frequency of 200 THz.

FIG. 5A shows an analysis result of a frequency response property of an optical property (an effective refractive index) of the sheet-type material having pattern arrays optimally configured for the designed frequency of 200 THz.

FIG. 5B shows an analysis result of a frequency response property of an optical property (reflected power and transmitted power) of the sheet-type material having the pattern arrays optimally configured for the designed frequency of 200 THz.

FIG. 5C shows an analysis result of a frequency response property of an optical property (a relative impedance) of the sheet-type material having the pattern arrays optimally configured for the designed frequency of 200 THz.

FIG. 5D shows an analysis result of a frequency response property of an optical property (a relative permittivity) of the sheet-type material having the pattern arrays optimally configured for the designed frequency of 200 THz.

FIG. 5E shows an analysis result of a frequency response property of an optical property (a relative permeability) of the sheet-type material having the pattern arrays optimally configured for the designed frequency of 200 THz.

FIG. 5F shows an analysis result of a frequency response property of an optical property (a phase lag) of the sheet-type material having the pattern arrays optimally configured for the designed frequency of 200 THz.

FIG. 6 shows a configuration of a thermal radiation lens using the sheet-type material according to the present embodiment.

FIG. 7 shows a configuration of the thermal radiation lens of a diffraction grating type using the sheet-type material according to the present embodiment.

FIG. 8 shows a configuration of a sheet-type material according to the first modification example.

FIG. 9 shows a configuration of a sheet-type material according to the second modification example.

FIG. 10 shows an analysis result of optimum design conditions of the sheet-type material for the designed frequency of 50 THz.

FIG. 11 shows an analysis result of optimum design conditions of the sheet-type material for the designed frequency of 200 THz.

### DESCRIPTION OF EXEMPLARY EMBODIMENTS

Hereinafter, the invention will be described through embodiments of the invention, but the following embodiments do not limit the invention according to claims. In addition, not all combinations of features described in the embodiments are necessarily essential to the solution of the invention.

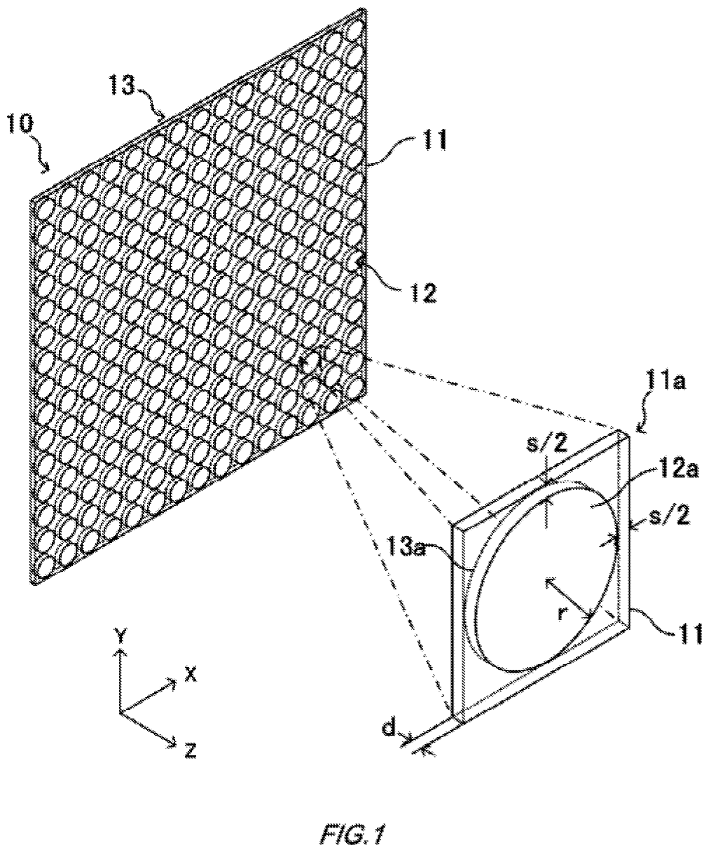

FIG. 1 shows a configuration of a sheet-type material 10 according to the present embodiment as well as an enlarged drawing of a configuration of a unit cell 11a. Here, the unit cell 11a is a basic unit of a periodic structure of the sheet-type material 10. The sheet-type material 10 is a material capable of realizing the high refractive-index, non-reflective, and non-polarizing optical properties for a frequency band of thermal radiation (in the present embodiment, particularly, the above-described typical 50 THz band of 8 THz to 200 THz and 200 THz band of 5 THz to 1000 THz), and includes a substrate 11, and first and second pattern arrays 12, 13.

The substrate 11 is a member in a hard plate form or in a flexible sheet or film form for retaining the first and second pattern arrays 12, 13. As the substrate 11, for example, a rectangular dielectric film having a thickness d, composed of benzocyclobutene (BCB (a relative permittivity of 2.7)), polyimide (a permittivity of 3.5), a quartz glass (SiO₂, a permittivity of 3.8), or silicon nitride (SiNx (a relative permittivity of ˜7), Si₃N₄ (a relative permittivity of 7.3)) can be employed. Note that metal such as chromium and titanium may be used as the material of the substrate 11, and may be used as a material of an adhesion layer thinly provided between the substrate 11 and meta-atoms 12a, 13a described later. Note that the size and shape of the substrate 11 may be arbitrarily selected.

A first pattern array (which is one example of a plurality of first patterns) 12 is an array of meta-atoms 12a arranged regularly on one surface (in the present embodiment, the +Z plane) of the substrate 11. The meta-atom 12a is, for example, formed as a thin film in a circular shape with radius r by using conductive metal, such as gold, silver, copper, and aluminum. The meta-atoms 12a are arranged regularly in the X-axis direction and the Y-axis direction; in other words, they are arranged to be equally spaced in each direction, by providing a constant gap s (that is, arranged in a square grid shape).

A second pattern array (one example of a plurality of second patterns) 13 is an array of meta-atoms 13a arranged regularly on the back surface (in the present embodiment, the −Z plane) of the substrate 11. The meta-atom 13a is formed as a thin film in a circular shape with radius r by using conductive metal, such as gold, silver, copper, and aluminum, that is, the same shape as the meta-atom 12a. The meta-atoms 13a are arranged regularly in the X-axis direction and the Y-axis direction; that is, arranged to be equally spaced in each direction, by providing a constant gap s (that is, arranged in a square grid shape) to overlap with the meta-atoms 12a of the first pattern array 12 at the same XY positions.

In other words, the sheet-type material 10 is configured by disposing, in the unit cell 11a, a meta-atom 12a at the center of the +Z plane, spaced apart from each of the four sides by distance s/2, by disposing a meta-atom 13a at the center of the −Z plane, spaced apart from each of the four sides by distance s/2, and by arranging the unit cells 11a in a matrix form in the X-axis direction and the Y-axis direction.

Note that the meta-atoms 12a, 13a of the first and second pattern arrays 12, 13 have been arranged in a square grid shape in the present embodiment, which is not limiting, and they may be arranged in any grid shape; for example, they may be arranged in a rectangular grid shape by providing different gaps each in the X-axis direction and the Y-axis direction, or may be arranged in a rhombic grid shape or a triangular grid shape by providing the equivalent gaps in each of the X-axis direction and a direction crossing the X-axis direction.

The first and second pattern arrays 12, 13 can be formed on the substrate 11 in an etching processing method, for example. First, on the +Z plane of the substrate 11, a metal film having a film thickness t is formed by using conductive metal, such as gold, for example. Note that the metal film may be formed in any method, such as mask vapor deposition and liftoff. Then, a photoresist is applied on this metal film, and a resist pattern having the same shape as the first pattern array 12 is formed by lithographic technology. Then, this resist pattern is used as a mask to perform etching processing on the metal film. Note that any etching processing method, such as wet etching and dry etching, may be used. Lastly, by detaching the resist pattern, the first pattern array 12 is formed on the +Z plane of the substrate 11. Similarly, on the −Z plane on the substrate 11, a metal film having film thickness t is formed by using conductive metal, such as gold, for example. Then, a photoresist is applied on this metal film, and a resist pattern having the same shape as the second pattern array 13 is formed by lithographic technology. Then, this resist pattern is used as a mask to perform etching processing on the metal film. Lastly, by detaching the resist pattern, the second pattern array 13 is formed on the −Z plane of the substrate 11.

Note that instead of such a method, the first and second pattern arrays 12, 13 may be formed in an inkjet method using a metal nano-ink.

Here, a case where thermal radiation is incident on the sheet-type material 10 which is configured as described above is discussed. When the thermal radiation enters the sheet-type material 10 (the unit cell 11a) from the −Z plane side toward the +Z direction, a portion thereof is reflected by the meta-atoms 12a, 13a of the sheet-type material 10 to the −Z direction and becomes a reflected wave, and the rest thereof penetrates the sheet-type material 10 in the +Z direction and becomes a transmitted wave. At this time, magnetic flux interlinks, and this causes current to flow between the meta-atoms 12a, 13a in an opposite direction, and then the meta-atoms 12a, 13a act as magnetic body particles having a large permeability. Particularly, a maximum permeability is presented at a resonance frequency of magnetism based on the size of the meta-atom 12a, 13a, or the like. In addition, polarization occurs due to an electric field, and then the meta-atoms 12a, 13a act as dielectric particles having a large permittivity. When the permeability and the permittivity have both large values, a high refractive index can be obtained. Here, in the sheet-type material 10 according to the present embodiment, the meta-atoms 12a, 13a each have a symmetrical circular shape in any direction in the XY-plane, and, therefore, the meta-atoms 12a, 13a show the behavior of such a permeability and permittivity for thermal radiation in any polarization direction.

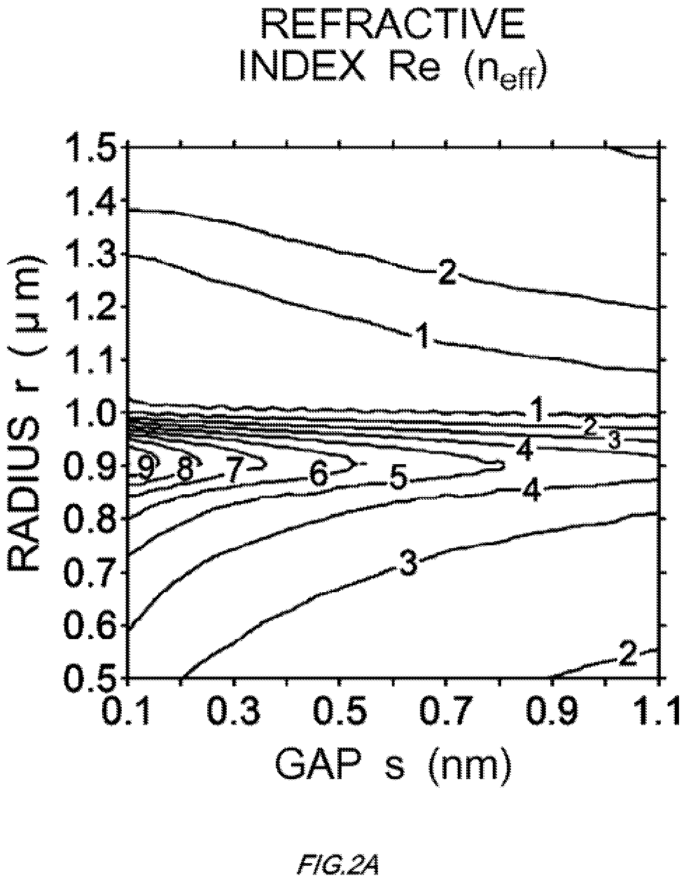

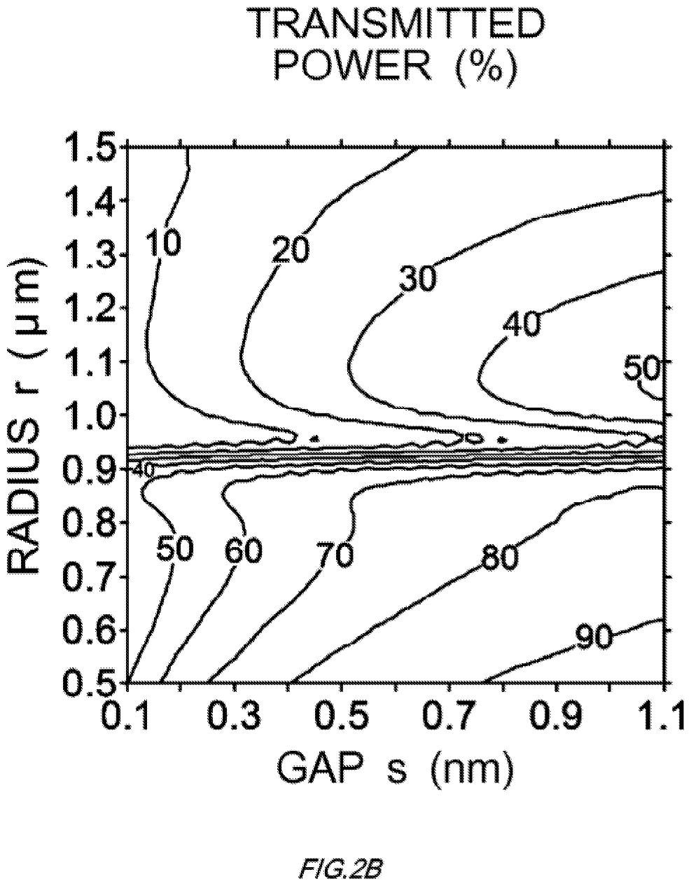

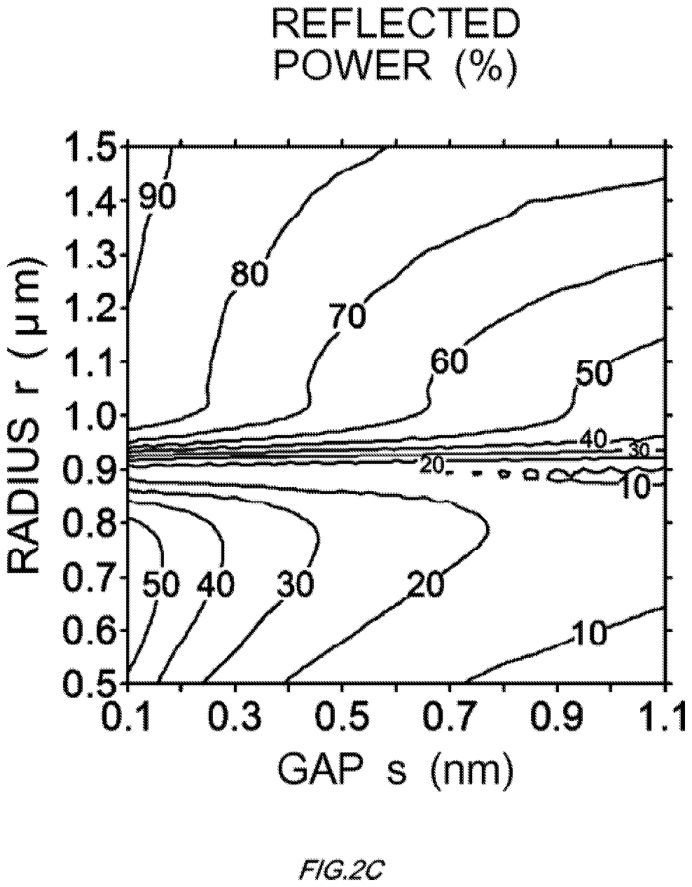

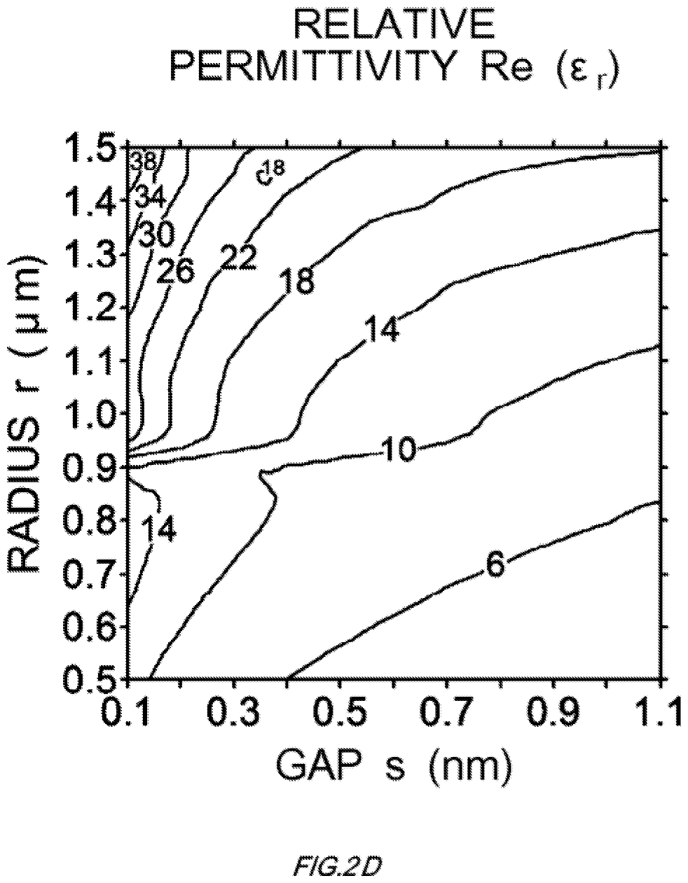

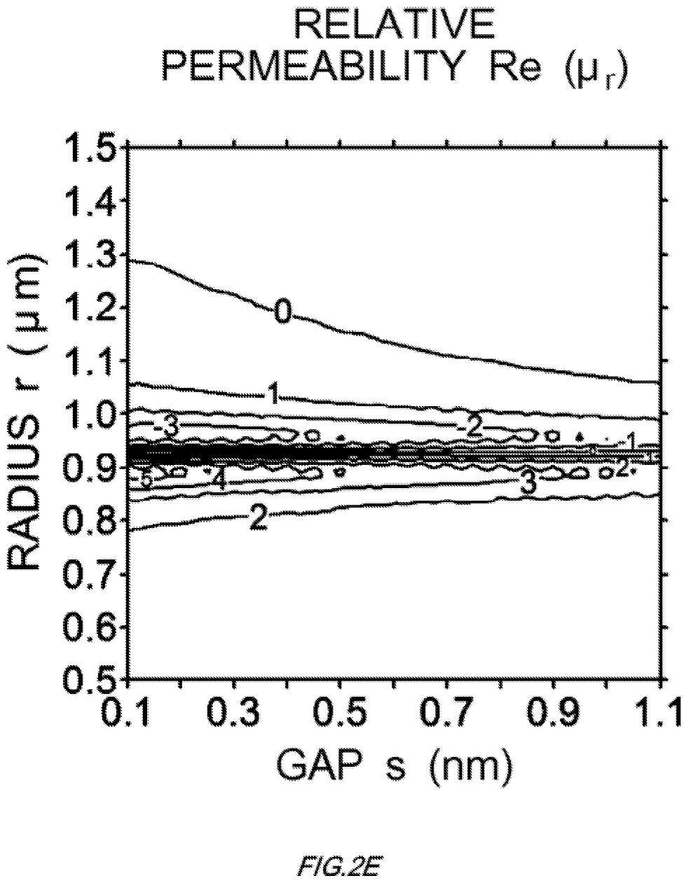

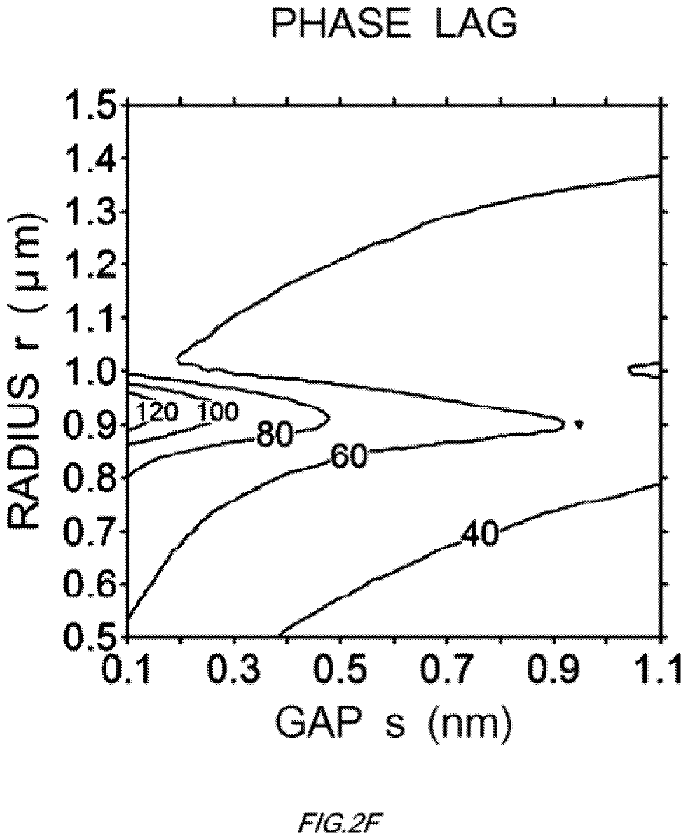

FIG. 2A to FIG. 2F show analysis results of optical properties of the pattern arrays for defining the design of the sheet-type material 10, particularly the designs of the first and second pattern arrays 12, 13, for a designed frequency of 50 THz (wavelength 6.0 μm). An analysis has been conducted on optical properties of the unit cell 11a, that is, an effective refractive index n_{eff}, transmitted power, reflected power, relative permittivity εᵣ, relative permeability μᵣ, and a phase lag, for the radius r (from 0.5 μm to 1.5 μm) and the gap s (from 0.1 μm to 1.1 μm) of the meta-atoms 12a, 13a, in a finite element method electromagnetic field simulator HFSS provided by ANSYS Inc. In the analysis, a periodic boundary condition has been imposed on the four sides of the unit cell 11a. Here, as the material of the substrate 11, benzocyclobutene, which has a relatively low relative permittivity and a good heat tolerance (the refractive index of 1.516+j0.008 at the relative permittivity of 2.7 and 50 THz), has been employed, assuming the thickness d=100 nm. As the material of the meta-atoms 12a, 13a, gold, which has high conductivity and good processability, has been employed, assuming the thickness (film thickness) t=50 nm. Note that, a conductivity σ_{AC}=(1+j2πfτ)σ_{DC}/(1+(2πfτ)²) of gold for a frequency f of thermal radiation has been given, where a D.C. conductivity σ_{DC}=4.1×10⁷S/m, the relaxation time τ=2.5×10⁻¹⁴ s, and a skin thickness δ=22 nm by complex conductivity (for 50 THz).

FIG. 2A shows a real component Re (n_{eff}) of an effective refractive index of the sheet-type material 10. The effective refractive index behaves in the following manner: the effective refractive index is the maximum at the radius r=0.9 μm and the gap s=0.1 μm; the effective refractive index is decreased as the radius r is increased from 0.9 μm to 1.5 μm and decreased from 0.9 μm to 0.5 μm; the effective refractive index is decreased as the gap s is increased from 0.1 μm to 1.1 μm. At the radius r=0.9 μm and the gap s=0.1 μm, the maximum value 10.12 of the real component Re (n_{eff}) of the effective refractive index (the imaginary component Im (n_{eff})=2.23) can be obtained.

FIG. 2B shows a transmitted power of the sheet-type material 10. The transmitted power behaves in the following manner: the transmitted power is almost zero at the radius r of approximately 0.9 μm or more; the transmitted power is finite at the radius r of approximately 0.9 or less; particularly, the transmitted power is increased at the radius r of 0.85 μm as the gap s is increased from 0.1 μm to 1.1 μm, and the transmitted power is increased as the radius r is decreased from approximately 0.8 μm and the gap s is increased from 0.1 μm to 1.1 μm. At the radius r=0.9 μm and the gap s=0.1 μm, the transmitted power of 41% can be obtained.

FIG. 2C shows reflected power of the sheet-type material 10. The reflected power behaves in the following manner: the reflected power is almost zero at the radius r of approximately 0.9 μm; the reflected power is finite for a range of the radius r of approximately 0.95 μm or more and for a range of the radius r of 0.5 μm to 0.85 μm and the gap s of 0.1 μm to approximately 0.4 μm. At the radius r=0.9 μm and the gap s=0.1 μm, the reflected power of 13% can be obtained.

FIG. 2D shows a real component Re (εᵣ) of a relative permittivity of the sheet-type material 10. The relative permittivity behaves in the following manner: the relative permittivity is increased as the radius r is increased from approximately 0.9 μm to 1.5 μm and as the gap s is decreased from 1.1 μm to 0.1 μm; the relative permittivity is decreased as the radius r is decreased from approximately 0.9 μm and as the gap s is increased from 0.1 μm to 1.1 μm. At the radius r=0.9 μm and the gap s=0.1 μm, a value 13.27 of the real component Re (εᵣ) of the relative permittivity (the imaginary component Im (εᵣ)=−3.94) can be obtained.

FIG. 2E shows a real component Re (μᵣ) of relative permeability of the sheet-type material 10. The relative permeability behaves in the following manner: the relative permeability is the maximum at the radius r=0.9 μm and the gap s=0.1 μm; the relative permeability is decreased as the radius r is increased from 0.9 μm to approximately 0.95 μm and decreased from 0.9 μm to 0.5 μm; the effective refractive index is decreased as the gap s is increased from 0.1 μm to 1.1 μm. At the radius r=0.9 μm and the gap s=0.1 μm, the maximum value 5.82 of the real component Re (μᵣ) of the relative permeability (the imaginary component Im (μᵣ)=5.13) can be obtained.

FIG. 2F shows a phase lag (for a thickness d of the substrate 11+a film thickness 2t of the meta-atoms 12a, 13a) of the sheet-type material 10. The phase lag behaves in the following manner: the phase lag is the maximum at the radius r=0.9 μm and the gap s=0.1 μm; the phase lag is decreased as the radius r is increased from 0.9 μm to 1.5 μm and decreased from 0.9 μm to 0.5 μm; the phase lag is decreased as the gap s is increased from 0.1 μm to 1.1 μm.

From the above-mentioned analysis result of the optical properties of the pattern arrays, it is understood that desired high refractive-index, low reflective, and non-polarizing properties can be obtained, for the designed frequency of 50 THz, when the radius r of the meta-atoms 12a, 13a is from 0.85 μm to 0.965 μm, more preferably, from 0.875 to 0.93 μm, and when the gap s is from 0.1 to 0.3 μm, more preferably, from 0.1 μm to 0.2 μm, and particularly, the high refractive index of 10.12(+j2.23) and the low reflectivity of 13% can be obtained at the radius r=0.9 μm and the gap s=0.1 μm, at which the relative permeability becomes the maximum.

Note that the diameter 1.8 μm of the meta-atoms 12a, 13a, obtained from the optimum radius 0.9 μm determined as described above, is approximately identical with the half (approximately 2.0 μm) of the effective wavelength (a wavelength in the substrate 11) of the designed frequency of 50 THz (the wavelength of 6 μm).

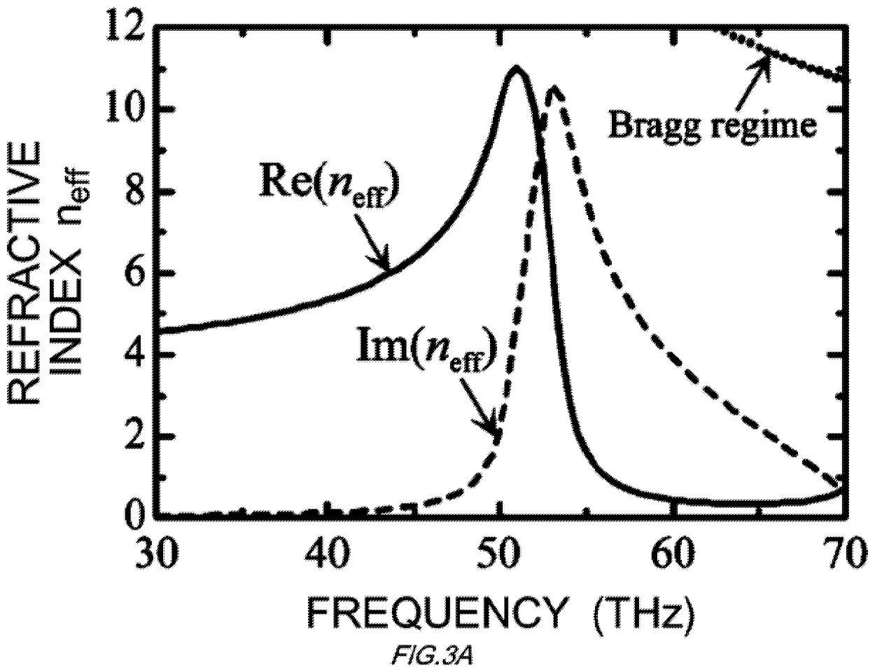

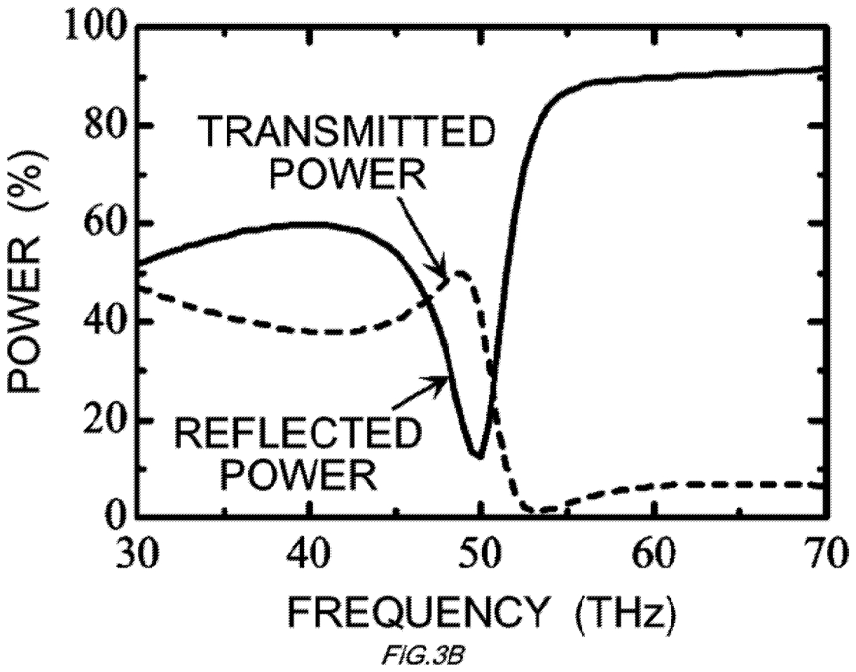

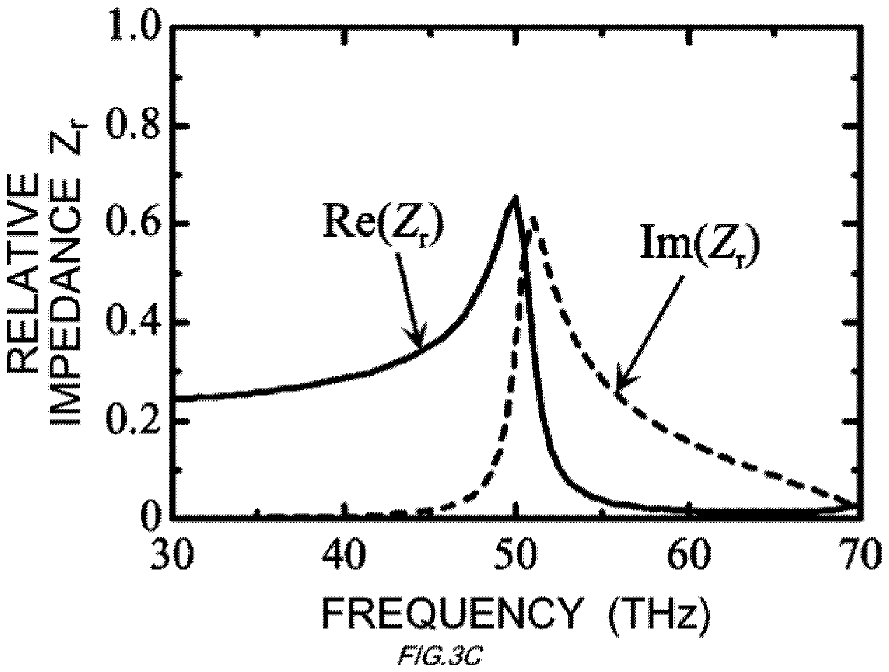

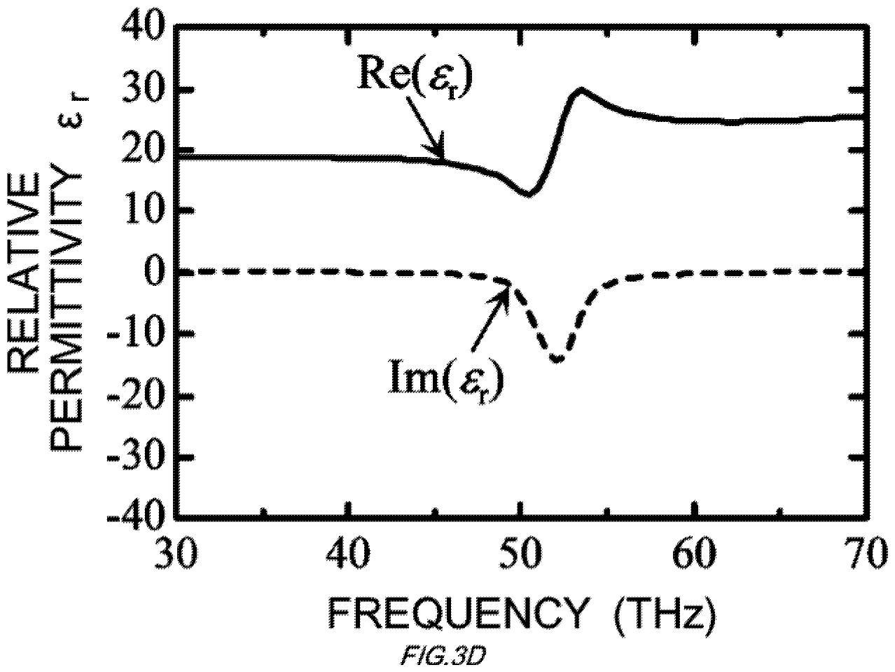

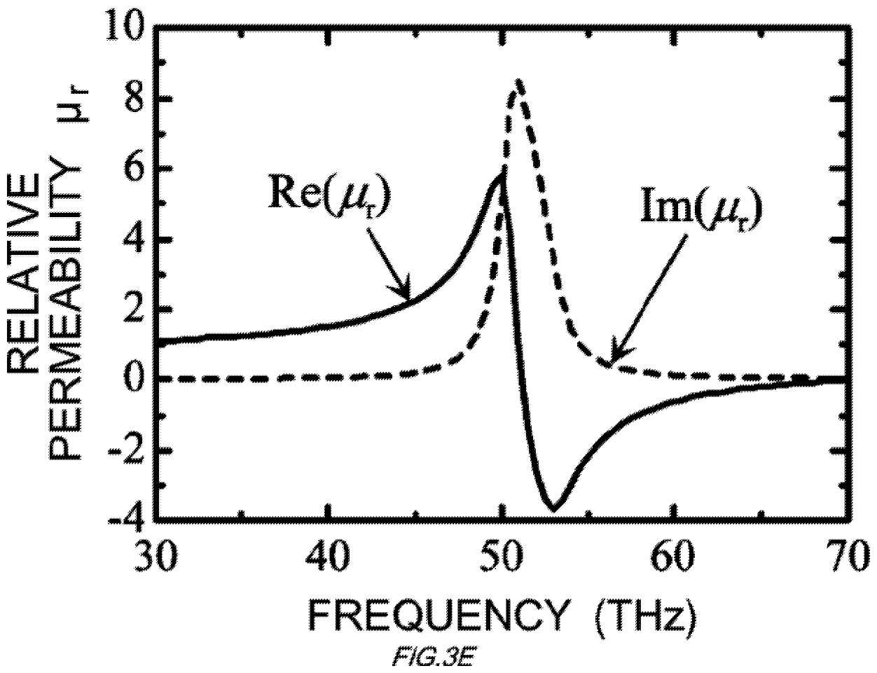

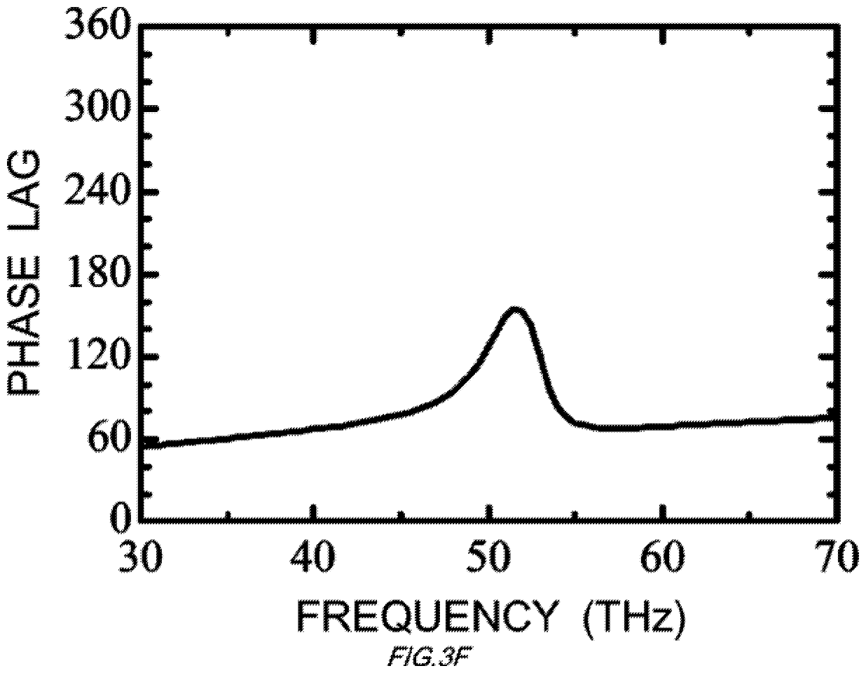

FIG. 3A to FIG. 3F show analysis results of frequency response properties of optical properties of the sheet-type material 10 having the pattern arrays optimally designed for the designed frequency of 50 THz as described above. The meta-atoms 12a, 13a in the optimally designed pattern arrays have the radius r=0.9 μm and the gap s=0.1 μm. However, the substrate 11 has the thickness d=100 nm, and the meta-atoms 12a, 13a have the film thickness t=50 nm. An analysis has been conducted on frequency response properties of optical properties, that is, an effective refractive index n_{eff}, transmitted power, reflected power, relative permittivity εᵣ, relative permeability μᵣ, and a phase lag, of the unit cell 11a, including such meta-atoms 12a, 13a, in the finite element method electromagnetic field simulator HFSS provided by ANSYS Inc. Other analysis conditions are the same as described earlier.

FIG. 3A shows the frequency response properties of an effective refractive index n_{eff} of the sheet-type material 10. The real component of the effective refractive index behaves in the following manner: the real component is approximately 4.5 at the frequency of 30 THz; the real component is increased as the frequency is increased; the real component is the maximum at the frequency of approximately 50 THz; the real component is sharply decreased as the frequency is further increased; the real component becomes constant at approximately 0.5 at the frequency of approximately 60 THz or more. The imaginary component of the effective refractive index behaves in the following manner: the imaginary component is zero at the frequency of 30 THz; the imaginary component begins to be sharply increased when the frequency exceeds approximately 50 THz, the imaginary component is the maximum at the frequency of approximately 53 THz; the imaginary component is decreased gradually as the frequency is further increased. At the designed frequency of 50 THz, the effective refractive index n_{eff}=10.12+j2.23, which has the maximum real component, can be obtained.

FIG. 3B shows the frequency response properties of reflected power and transmitted power of the sheet-type material 10. The reflected power behaves in the following manner: the reflected power is gradually increased as the frequency is increased from 30 THz; the reflected power begins to be decreased as the frequency is further increased over approximately 40 THz; the reflected power is the minimum at the frequency of 50 THz; the reflected power is sharply increased as the frequency is further increased over 50 THz; the reflected power becomes constant at approximately 90% at the frequency of 55 THz or more. The transmitted power behaves in the following manner: the transmitted power is gradually decreased as the frequency is increased from 30 THz; the transmitted power begins to be increased as the frequency is further increased over approximately 40 THz; the transmitted power is the maximum at the frequency of approximately 50 THz; the transmitted power is sharply decreased as the frequency is further increased over 50 THz; the transmitted power is zero at the frequency of approximately 53 THz; the transmitted power becomes constant at approximately 8% at the frequency of approximately 60 THz or more. At the designed frequency of 50 THz, the reflected power of 13% and the transmitted power of 41% can be obtained.

FIG. 3C shows the frequency response properties of relative impedance of the sheet-type material 10. The real component of the relative impedance behaves in the following manner: the real component is approximately 0.25 at the frequency of 30 THz; the real component is gradually increased as the frequency is increased; the real component is more sharply increased as the frequency is further increased over approximately 48 THz; the real component is the maximum at the frequency of 50 THz; the real component is sharply decreased as the frequency is further increased over 50 THz; the real component is attenuated to roughly zero at the frequency of approximately 55 THz or more. The imaginary component of the relative impedance behaves in the following manner: the imaginary component is approximately zero at the frequency of 30 THz; the imaginary component begins to be sharply increased as the frequency is increased over approximately 48 THz; the imaginary component is the maximum at the frequency of approximately 50 THz; the imaginary component is gradually decreased as the frequency is further increased over approximately 50 THz.

FIG. 3D shows the frequency response properties of relative permittivity of the sheet-type material 10. The real component of the relative permittivity behaves in the following manner: the real component is approximately 18 at the frequency of 30 THz; the real component is gradually decreased as the frequency is increased; the real component is the minimum at the frequency of 50 THz; the real component is sharply increased as the frequency is further increased over 50 THz; the real component is the maximum at the frequency of approximately 53 THz; the real component is gradually decreased as the frequency is further increased over approximately 53 THz. The imaginary component of the relative permittivity behaves in the following manner: the imaginary component is zero at the frequency of 30 THz; the imaginary component is sharply decreased as the frequency is increased over 50 THz; the imaginary component is the minimum at the frequency of approximately 52 THz; the imaginary component is sharply increased as the frequency is further increased over approximately 52 THz; the imaginary component is saturated to be zero at the frequency of approximately 55 THz or more. At the designed frequency of 50 THz, the relative permittivity 13.27-j3.94 can be obtained.

FIG. 3E shows the frequency response properties of relative permeability of the sheet-type material 10. The real component of the relative permeability behaves in the following manner: the real component is approximately one at the frequency of 30 THz; the real component is gradually increased as the frequency is increased; the real component is sharply increased as the frequency is further increased over approximately 45 THz; the real component is the maximum at the frequency of 50 THz; the real component is sharply decreased as the frequency is further increased over 50 THz; the real component is the minimum at the frequency of approximately 53 THz; the real component is gradually increased and becomes zero as the frequency is further increased over approximately 53 THz. The imaginary component of the relative permittivity behaves in the following manner: the imaginary component is zero at the frequency of 30 THz; the imaginary component is sharply increased as the frequency is increased over approximately 48 THz; the imaginary component is

the maximum at the frequency of approximately 50 THz; the imaginary component is sharply decreased as the frequency is further increased over approximately 50 THz; the imaginary component is attenuated to be zero at the frequency of approximately 56 THz or more. At the designed frequency of 50 THz, the relative permeability of 5.82+j5.13 can be obtained.

FIG. 3F shows the frequency response properties of a phase lag (for the thickness d of the substrate 11+the film thickness 2t of the meta-atoms 12a, 13a) of the sheet-type material 10. The phase lag behaves in the following manner: the phase lag is approximately 60 degrees at the frequency of 30 THz; the phase lag is sharply increased as the frequency is further increased over approximately 48 THz and the phase lag reaches 160 degrees at the frequency of approximately 52 THz; the phase lag is sharply decreased as the frequency is further increased over approximately 52 THz; the phase lag becomes constant at approximately 70 degrees at the frequency of approximately 57 THz or more.

From the above-mentioned analysis result of the frequency response properties of the optical properties of the pattern arrays, the high refractive index of 10.12 (+j2.23), the low reflectivity of 13%, and the non-polarizing properties can be obtained for the designed frequency of 50 THz. In addition, by changing at least one of the radius r and the gap s of the meta-atoms 12a, 13a, the refractive index can be changed. Thus, it is understood that a thermal radiation lens 18 can be configured by utilizing the pattern arrays of the sheet-type material 10 according to the present embodiment.

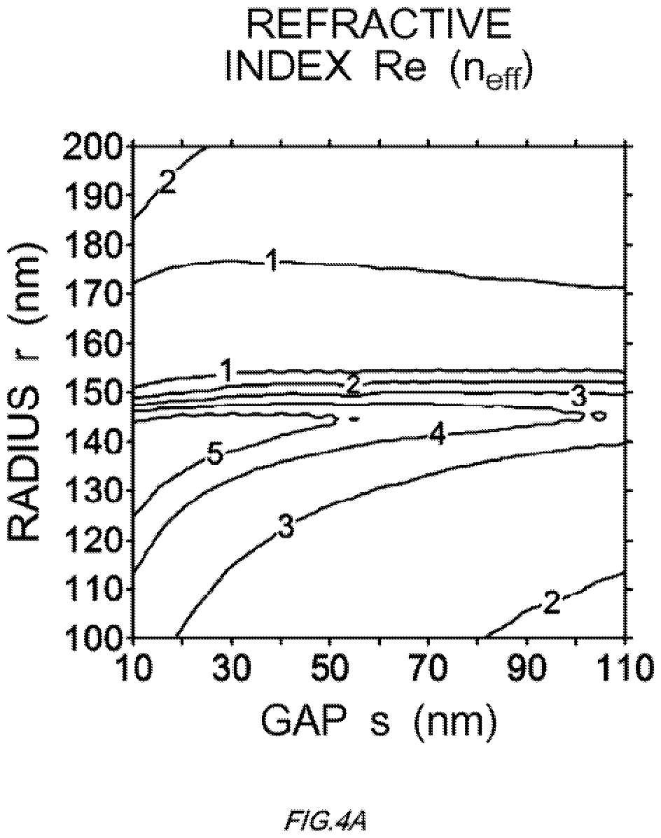

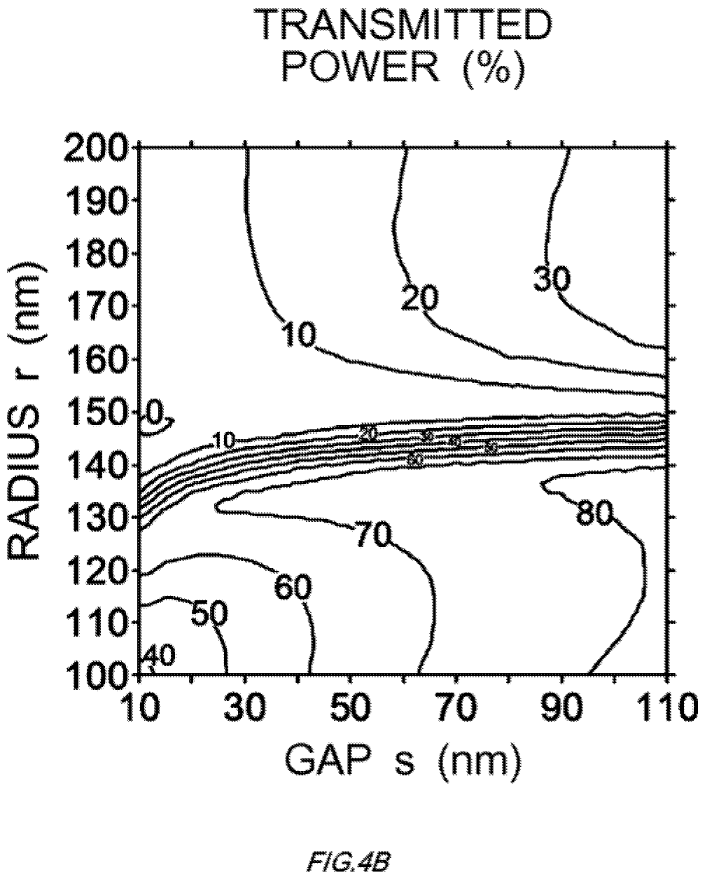

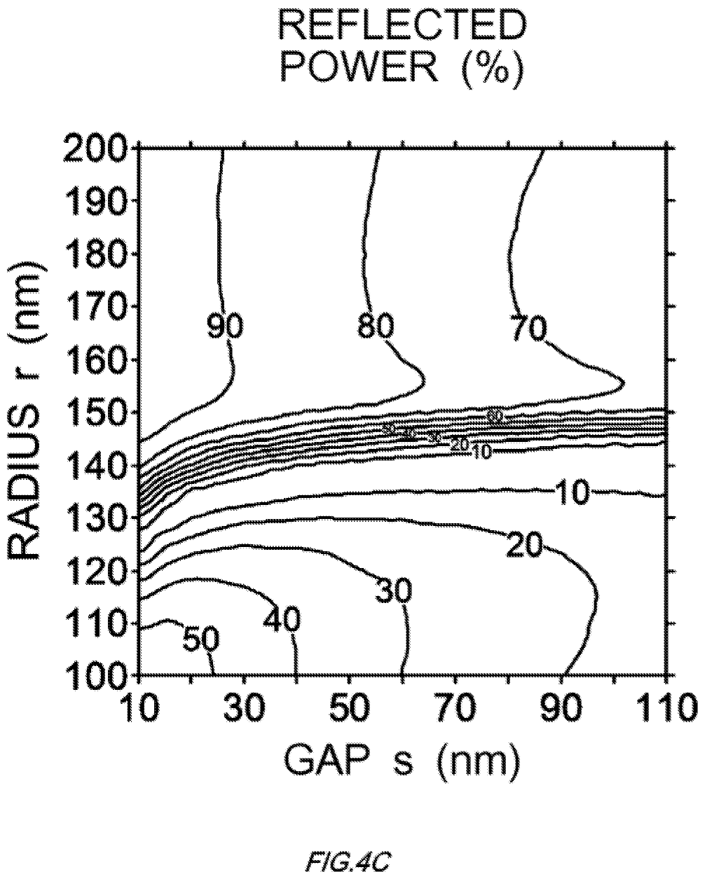

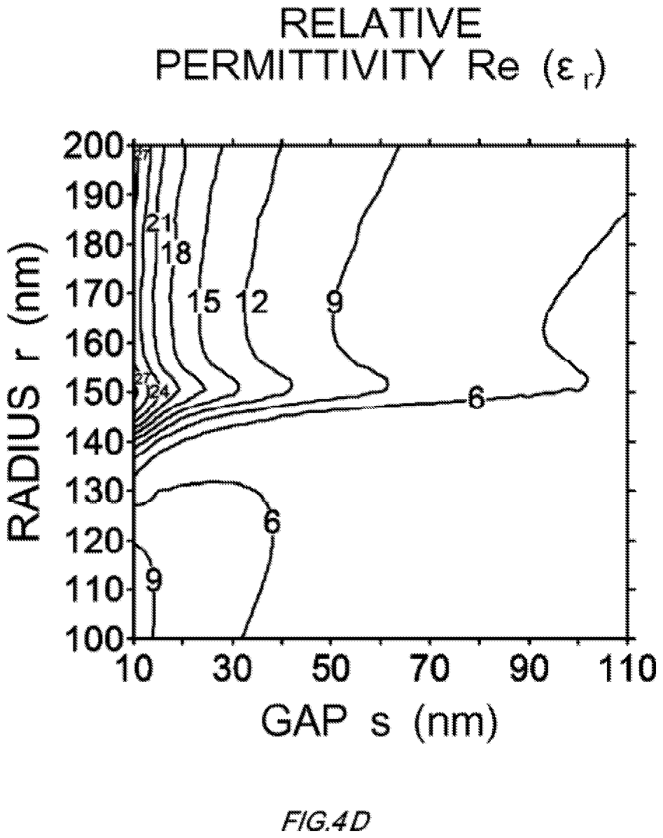

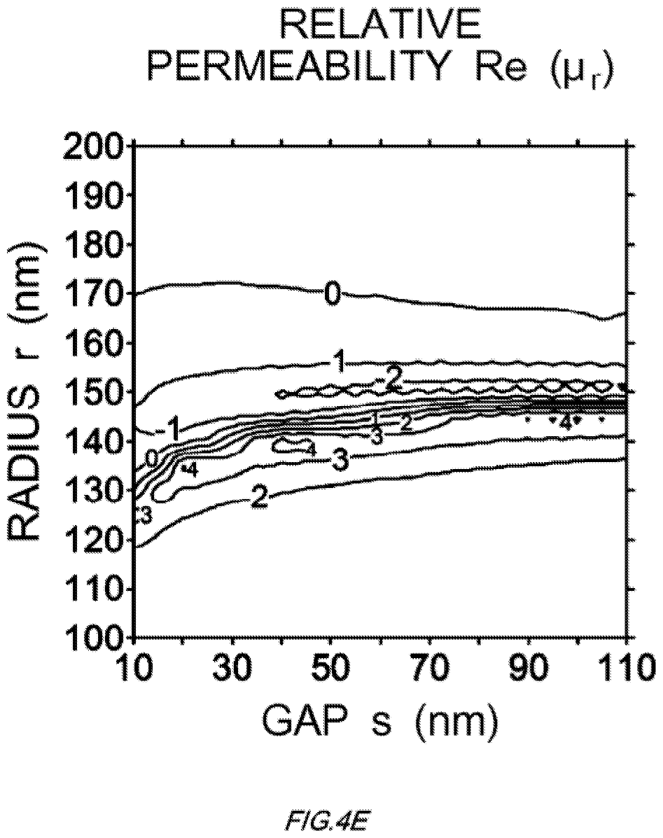

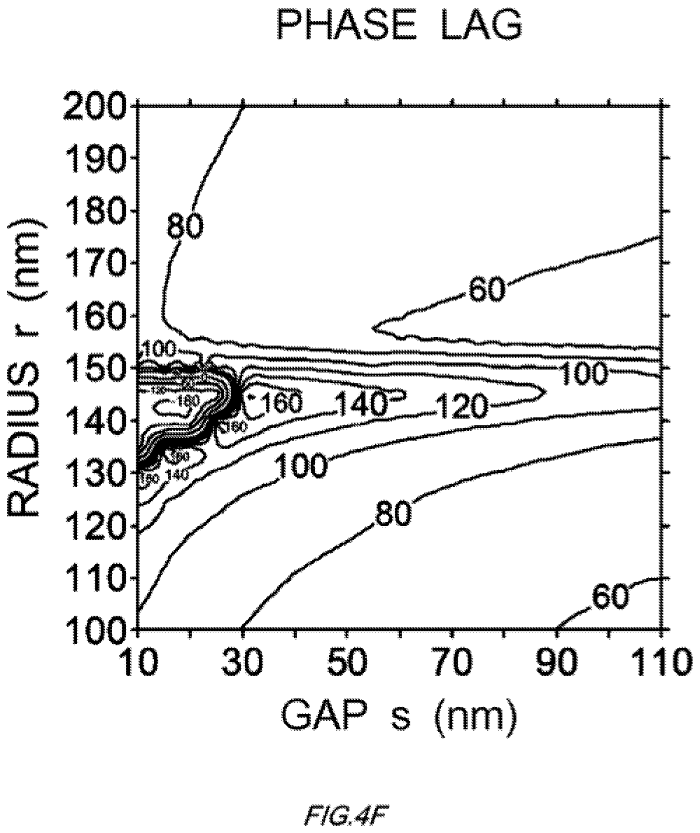

FIG. 4A to FIG. 4F show analysis results of optical properties of pattern arrays for defining the design of the sheet-type material 10, particularly the designs of the first and second pattern arrays 12, 13, for a designed frequency of 200 THz (wavelength 1.5 μm). An analysis has been conducted on optical properties of the unit cell 11a, that is, an effective refractive index n_{eff}, transmitted power, reflected power, relative permittivity εᵣ, relative permeability μᵣ, and a phase lag, for the radius r (from 100 nm to 200 nm) and the gap s (from 10 nm to 110 nm) of the meta-atoms 12a, 13a, in the finite element method electromagnetic field simulator HFSS provided by ANSYS Inc. In the analysis, a periodic boundary condition has been imposed on the four sides of the unit cell 11a. Here, as the material of the substrate 11, benzocyclobutene (the refractive index of 1.543+j0.008 at the relative permittivity of 2.7 and 200 THz) has been employed again, assuming he thickness d=20 nm. As the material of the meta-atoms 12a, 13a, gold has been employed again, assuming the thickness (film thickness) t=50 nm. Note that, the conductivity σ_{AC}=(1+j2πfτ)σ_{DC}/(1+(2πfτ)²) of gold for a frequency f of thermal radiation has been given, where the D.C. conductivity σ_{DC}=4.1×10⁷ S/m, a relaxation time τ=2.5×10⁻¹⁴ s, and the skin thickness δ=22 nm by complex conductivity (for 200 THz).

FIG. 4A shows a real component Re (n_{eff}) of the effective refractive index of the sheet-type material 10. The effective refractive index behaves in the following manner: the effective refractive index is the maximum at the radius r=130 nm and the gap s=10 nm; the effective refractive index is decreased as the radius r is increased from 130 nm to 200 nm and decreased from 130 nm to 100 nm; the effective refractive index is decreased as the gaps is increased from 10 nm to 110 nm. At the radius r=130 nm and the gap s=10 nm, the maximum value 5.74 of the real component Re (n_{eff}) of the effective refractive index (the imaginary component Im (n_{eff})=1.03) can be obtained.

FIG. 4B shows transmitted power of the sheet-type material 10. The transmitted power behaves in the following manner: the transmitted power is almost zero at the radius r of approximately 140 nm or more; the transmitted power is finite at the radius r of approximately 140 or less; particularly, the transmitted power is increased at the radius r of 130 nm as the gap s is increased from 10 nm to 110 nm, and the transmitted power is increased as the radius r is decreased from approximately 120 nm and as the gap s is increased from 10 nm to 110 nm. At the radius r=130 nm and the gap s=10 nm, the transmitted power of 51% can be obtained.

FIG. 4C shows reflected power of the sheet-type material 10. The reflected power behaves in the following manner: the reflected power is almost zero at the radius r of approximately 130 nm; the reflected power is finite for a range of the radius r of approximately 140 nm or more and for a range of the radius r of 100 nm to 120 nm and the gap s of 10 nm to approximately 40 nm. At the radius r=130 nm and the gap s=10 nm, the reflected power of 16% can be obtained.

FIG. 4D shows a real component Re (εᵣ) of the relative permittivity of the sheet-type material 10. The relative permittivity behaves in the following manner: the relative permittivity is the maximum at the radius r=150 nm and the gap s=10 nm; the relative permittivity is decreased as the radius r is increased from 150 nm or decreased from 150 nm or as the gap s is increased from 10 nm. At the radius r=130 nm and the gap s=10 nm, a value 5.54 of a real component Re (εᵣ) of the relative permittivity (the imaginary component Im (εᵣ)=−2.39) can be obtained.

FIG. 4E shows a real component Re (μᵣ) of relative permeability of the sheet-type material 10. The relative permeability behaves in the following manner: the relative permeability is roughly the maximum at the radius r=130 nm and the gap s=10 nm; the relative permeability is decreased as the radius r is increased from 130 nm to approximately 150 nm and decreased from 130 nm to 100 nm; the effective refractive index is decreased as the gap s is increased from 10 nm to 110 nm. At the radius r=130 nm and the gap s=10 nm, the maximum value 4.10 of the real component Re (μᵣ) of the relative permeability (the imaginary component Im (μᵣ)=2.73) can be obtained.

FIG. 4F shows a phase lag (for a thickness d of the substrate 11+a film thickness 2t of the meta-atoms 12a, 13a) of the sheet-type material 10. The phase lag behaves in the following manner: the phase lag is the maximum for a range of the radius r=130 nm to 145 nm and the gap s=10 nm to 40 nm; the phase lag is decreased as the radius r is increased from this range to 200 nm and decreased from this range to 100 nm; the phase lag is decreased as the gaps is increased from this range to 110 nm.

From the above-mentioned analysis result of the optical properties of the pattern arrays, it is understood that desired high refractive-index, low reflective, and non-polarizing properties can be obtained, for the designed frequency of 200 THz, when the radius r of the meta-atoms 12a, 13a is from 120 nm to 145 nm, more preferably, from 130 nm to 140 nm, and when the gaps is from 10 nm to 60 nm, more preferably, from 10 nm to 20 nm, and particularly, a high refractive index 5.74(+j1.03) and a low reflectivity 16% can be obtained at the radius r=130 nm and the gap s=10 nm, at which the relative permeability becomes the maximum.

Note that the diameter 260 nm of the meta-atoms 12a, 13a, obtained from the optimum radius 130 nm determined as described above, is approximately half of the half (approximately 490 nm) of the effective wavelength (a wavelength in the substrate 11) of the designed frequency of 200 THz (wavelength 1.5 μm).

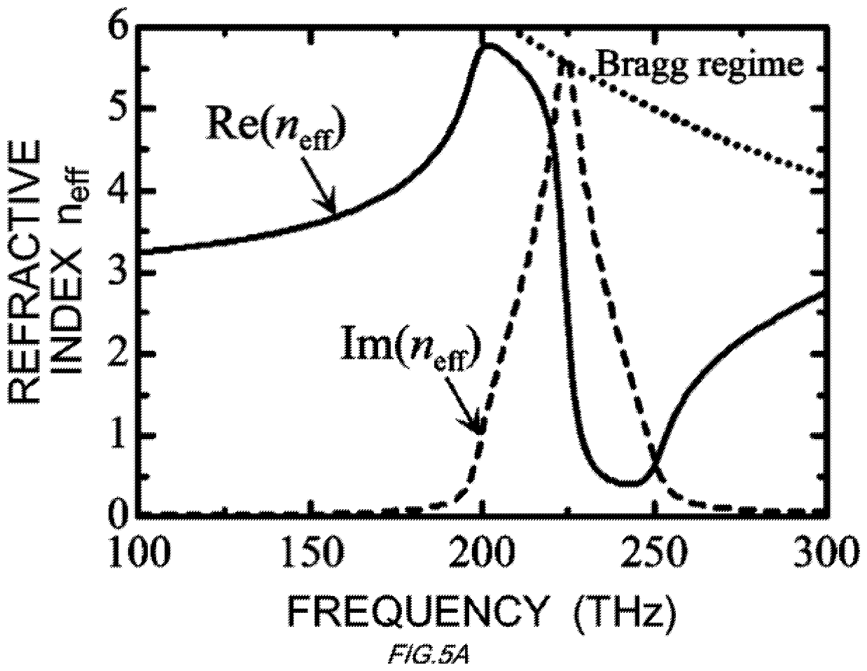

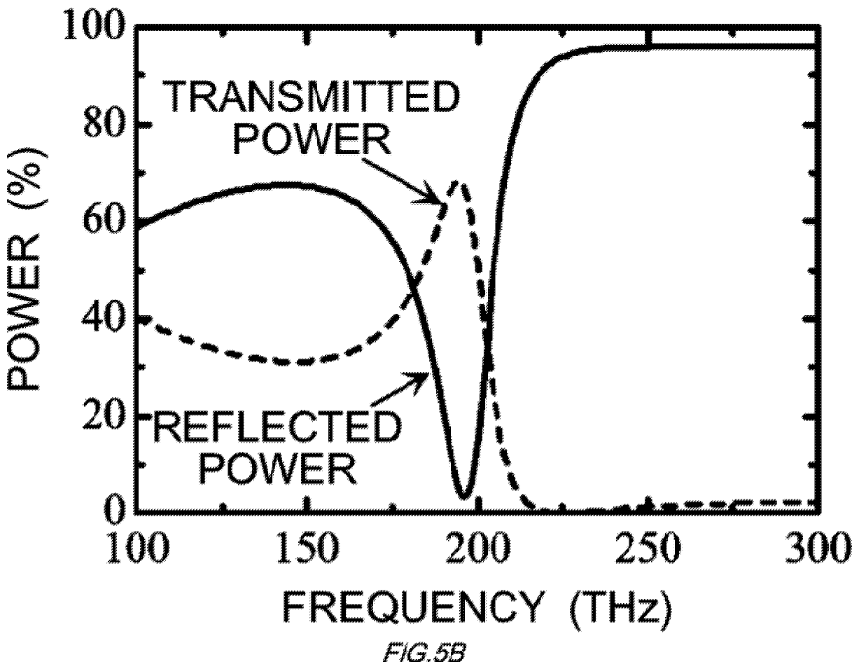

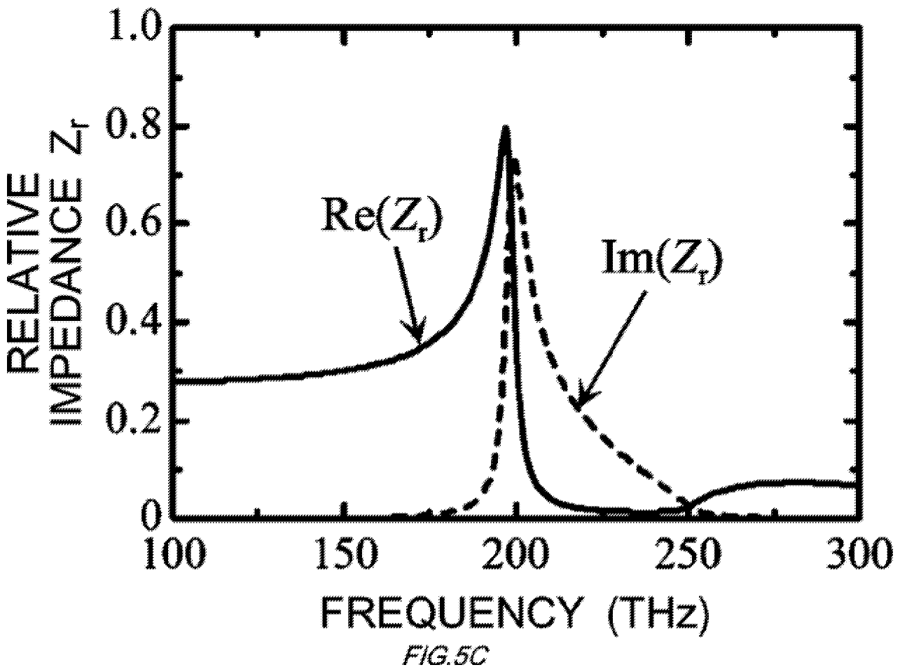

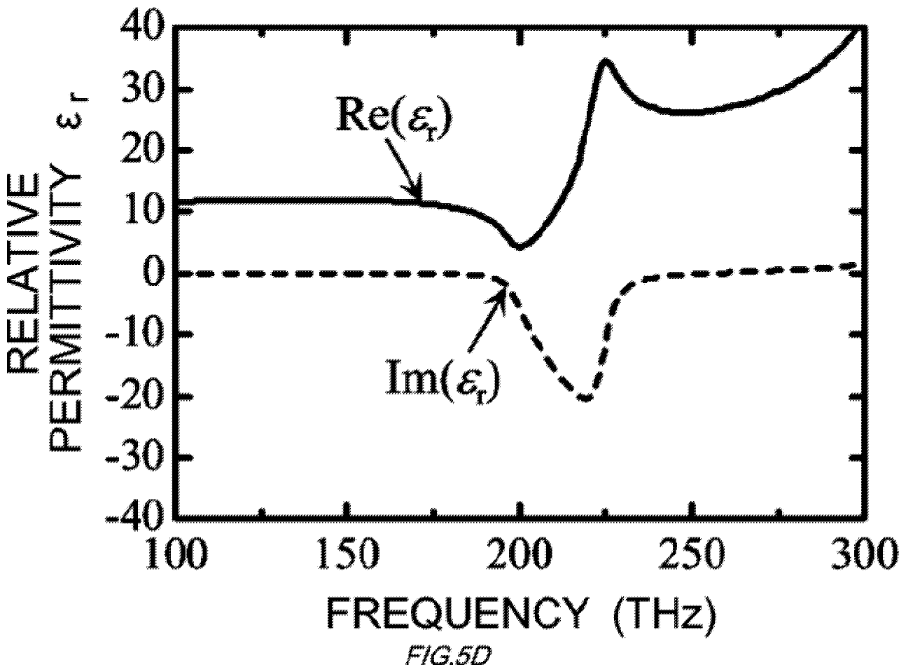

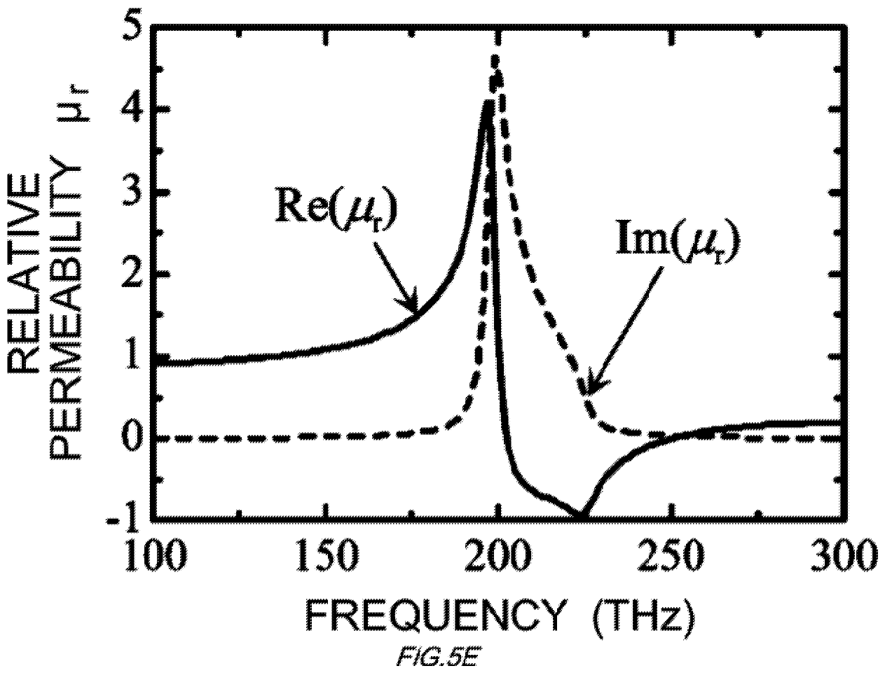

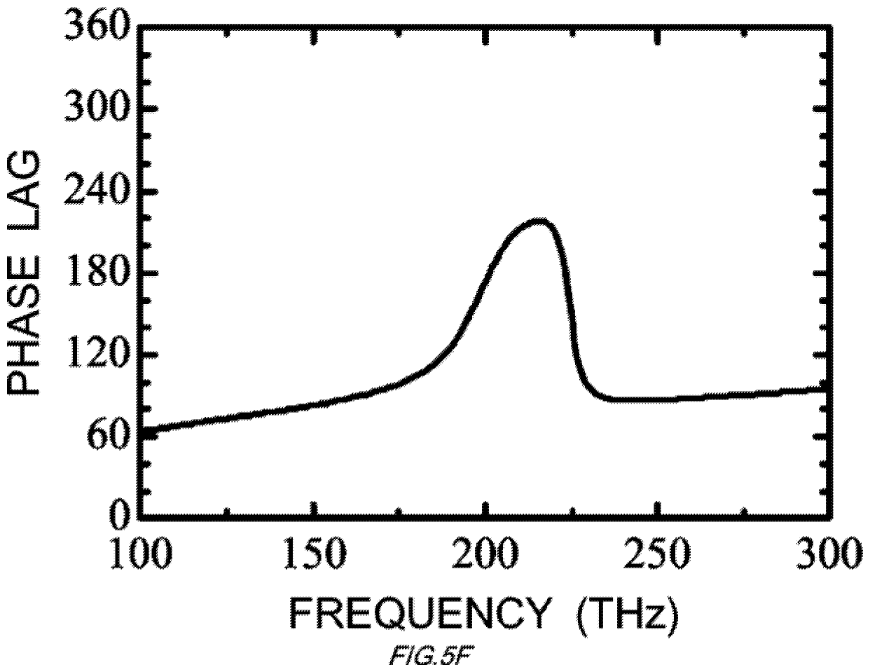

FIG. 5A to FIG. 5F show analysis results of frequency response properties of the optical properties of the sheet-type material 10 having the pattern arrays optimally designed for the designed frequency of 200 THz as described above. The meta-atoms 12a, 13a in the optimally designed pattern arrays have the radius r=130 nm and the gap s=10 nm. However, the substrate 11 has the thickness d=20 nm, and the meta-atoms 12a, 13a have the film thickness t=50 nm. An analysis has been conducted on frequency response properties of optical properties, that is, an effective refractive index n_{eff}, transmitted power, reflected power, relative permittivity εᵣ, relative permeability Pr, and a phase lag, of the unit cell 11a, including such meta-atoms 12a, 13a, in the finite element method electromagnetic field simulator HFSS provided by ANSYS Inc. Other analysis conditions are the same as described earlier.

FIG. 5A shows frequency response properties of an effective refractive index n_{eff} of the sheet-type material 10. The real component of the effective refractive index behaves in the following manner: the real component is approximately 3.5 at the frequency of 100 THz; the real component is increased as the frequency is increased; the real component is the maximum at the frequency of approximately 200 THz; the real component is sharply decreased as the frequency is further increased, the real component is the minimum at the frequency of approximately 240 THz; the real component is gradually increased as the frequency is further increased over approximately 240 THz or more. The imaginary component of the effective refractive index behaves in the following manner: the imaginary component is zero at the frequency of 100 THz; the imaginary component begins to be increased when the frequency exceeds approximately 200 THz, the imaginary component is the maximum at the frequency of approximately 225 THz; the imaginary component is sharply decreased as the frequency is further increased. At the designed frequency of 200 THz, the effective refractive index n_{eff}=5.74+j1.03, which has the maximum real component, can be obtained.

FIG. 5B shows the frequency response properties of reflected power and transmitted power of the sheet-type material 10. The reflected power behaves in the following manner: the reflected power is gradually decreased as the frequency is increased from 100 THz; the reflected power begins to be sharply decreased as the frequency is further increased over approximately 150 THz; the reflected power is the minimum at the frequency of approximately 200 THz; the reflected power is sharply increased as the frequency is further increased over approximately 200 THz; the reflected power becomes constant at approximately 95% at the frequency of approximately 220 THz or more. The transmitted power behaves in the following manner: the transmitted power is gradually decreased as the frequency is increased from 100 THz; the transmitted power begins to be sharply increased as the frequency is further increased over approximately 150 THz; the transmitted power is the maximum at the frequency of approximately 200 THz; the transmitted power is sharply decreased as the frequency is further increased over approximately 200 THz; the transmitted power is attenuated almost zero at the frequency of 220 THz or more. At the designed frequency of 200 THz, the reflected power of 16% and the transmitted power of 51% can be obtained.

FIG. 5C shows the frequency response properties of relative impedance of the sheet-type material 10. The real component of the relative impedance behaves in the following manner: the real component is approximately 0.3 at the frequency of 100 THz; the real component is gradually increased as the frequency is increased; the real component is more sharply increased as the frequency is further increased over approximately 180 THz; the real component is the maximum at the frequency of approximately 200 THz; the real component is sharply decreased as the frequency is further increased over approximately 200 THz; the real component is attenuated to almost zero at the frequency of approximately 220 THz or more. The imaginary component of the relative impedance behaves in the following manner: the imaginary component is approximately zero at the frequency of 100 THz; the imaginary component is sharply increased as the frequency begins to be increased over approximately 190 THz; the imaginary component is the maximum at the frequency of 200 THz; the imaginary component is gradually decreased as the frequency is further increased over 200 THz.

FIG. 5D shows the frequency response properties of relative permittivity of the sheet-type material 10. The real component of the relative permittivity behaves in the following manner: the real component is approximately 12 at the frequency of 100 THz; the real component is gradually decreased as the frequency is increased; the real component is the minimum at the frequency of 200 THz; the real component is sharply increased as the frequency is further increased over 200 THz; the real component is the local maximum at the frequency of approximately 225 THz; the real component is gradually increased after temporarily decreased as the frequency is further increased over approximately 225 THz. The imaginary component of the relative permittivity behaves in the following manner: the imaginary component is zero at the frequency of 150 THz; the imaginary component is sharply decreased as the frequency is increased over 200 THz; the imaginary component is the minimum at the frequency of approximately 220 THz; the imaginary component is sharply increased as the frequency is further increased over approximately 220 THz; the imaginary component is saturated to be zero at the frequency of approximately 240 THz or more. At the designed frequency of 200 THz, the relative permittivity of 5.54-j2.39 can be obtained.

FIG. 5E shows the frequency response properties of relative permeability of the sheet-type material 10. The real component of the relative permeability behaves in the following manner: the real component is approximately 1 at the frequency of 100 THz; the real is gradually increased as the frequency is increased; the real component is sharply increased as the frequency is further increased over approximately 180 THz; the real component is the maximum at the frequency of approximately 200 THz; the real component is sharply decreased as the frequency is further increased over approximately 200 THz; the real component is the minimum at the frequency of approximately 225 THz; the real component is gradually increased and becomes zero as the frequency is further increased over approximately 225 THz. The imaginary component of the relative permittivity behaves in the following manner: the imaginary component is zero at the frequency of 100 THz; the imaginary component is sharply increased as the frequency is increased over approximately 190 THz; the imaginary component is the maximum at the frequency of approximately 200 THz; the imaginary component is gradually decreased as the frequency is further increased over approximately 200 THz; the imaginary component is attenuated to be zero at the frequency of approximately 225 THz or more. At the designed frequency of 200 THz, the relative permeability of 4.10+j2.73 can be obtained.

FIG. 5F shows frequency response properties of a phase lag of the sheet-type material 10. The phase lag behaves in the following manner: the phase lag is approximately 60 degrees at the frequency of 100 THz; the phase lag is sharply increased as the frequency is further increased over approximately 180 THz; the phase lag reaches 220 degrees at the frequency of approximately 210 THz; the phase lag is sharply decreased as the frequency is further increased over approximately 210 THz; the phase lag is approximately 90 degrees constantly at the frequency of approximately 230 THz or more.

From the analysis result of the frequency response properties of the optical properties of the above-mentioned pattern arrays, the high refractive index of 5.74 (+j1.03), the low reflectivity of 16%, and the non-polarizing properties can be obtained for the designed frequency of 200 THz. In addition, by changing at least one of the radius r and the gaps of the meta-atoms 12a, 13a, the refractive index can be changed. Thus, it is understood that a thermal radiation lens 18 can be configured by utilizing the pattern arrays of the sheet-type material 10 according to the present embodiment.

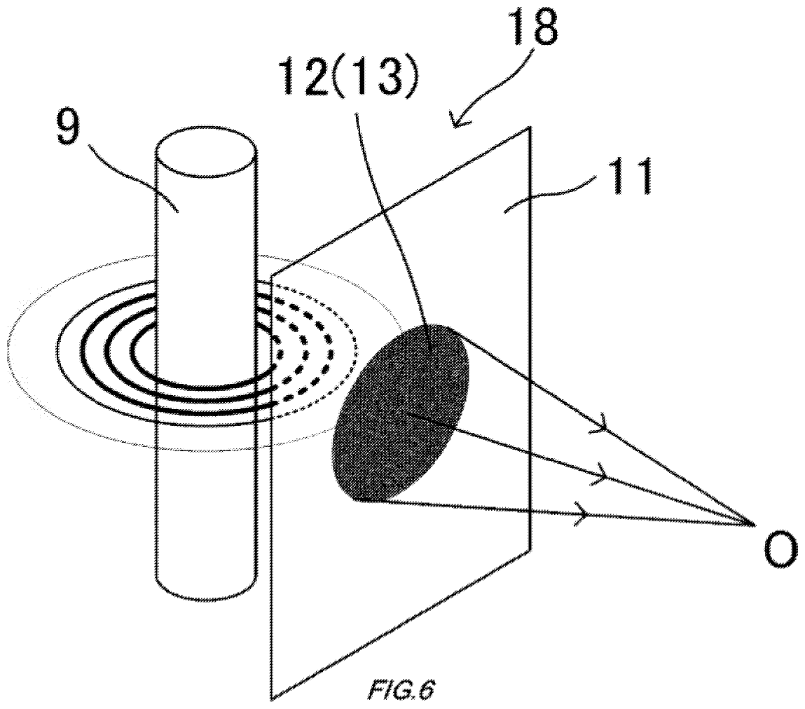

FIG. 6 shows a configuration of thermal radiation lens 18 utilizing the pattern arrays of the sheet-type material 10 according to the present embodiment. The thermal radiation lens 18 is configured in the same way as the sheet-type material 10 described earlier except that the first pattern array 12 is formed in only the central circular region on one surface of the substrate 11, and corresponding to this, the second pattern array 13 is formed on the back surface of the substrate 11 to overlap with the first pattern array 12. The refractive index of the thermal radiation lens 18 is increased in the center and is decreased in the circumference. If a heat source 9, such as a steelmaking slag, for example, is provided on the back surface side of the thermal radiation lens 18, thermal radiation released from the heat source 9 enters the thermal radiation lens 18 from the back surface side, and by its lens effect, the light is collected to be released toward a focus O located on the front surface side. The thermal radiation lens 18 enables collective control of the thermal radiation.

Note that the real component Re (n_{eff}) of the effective refractive index of the sheet-type material 10 behaves, in FIG. 2A and FIG. 4A, in the following manner: the real component Re (n_{eff}) is decreased as the gap s is increased from the optimum gap of the meta-atoms 12a, 13a; the real component Re (n_{eff}) is decreased as the radius r is increased or decreased from the optimum radius of the meta-atoms 12a, 13a. Thus, by densely arranging the meta-atoms 12a, 13a having a radius equivalent to the optimum radius with a gap equivalent to the optimum gap, the refractive index becomes large, and by sparsely arranging the meta-atoms 12a, 13a with a gap larger than the optimum gap or by arranging the meta-atoms 12a, 13a having a radius different from the optimum radius, the refractive index becomes small. Therefore, a refractive index distribution may be provided on the substrate 11 by densely arranging the meta-atoms 12a, 13a with a gap equivalent to the optimum gap in the central region of the substrate 11 and by sparsely arranging the meta-atoms 12a, 13a with a gap larger than the optimum gap in the surrounding region adjacent to the central region. In addition, a refractive index distribution may be provided on the substrate 11 by arranging the meta-atoms 12a, 13a having a radius equivalent to the optimum radius in the central region of the substrate 11 and by arranging the meta-atoms 12a, 13a having a radius different from the optimum radius in the surrounding region adjacent to the central region. Further, a refractive index distribution may be provided on the substrate 11 by arranging the meta-atoms 12a, 13a having a radius equivalent to the optimum radius with a gap equivalent to the optimum gap in the central region of the substrate 11 and by arranging the meta-atoms 12a, 13a having a radius different from the optimum radius (a larger or smaller radius) with a gap different from the optimum gap (a smaller or larger gap) in the surrounding region adjacent to the central region, but at the same pitch as that of the central region.

Note that the region, in which the first and second pattern arrays 12, 13 are formed, in the thermal radiation lens 18 is not limited to be the circular shape, and the region may be any shape having the lens effect for the thermal radiation.

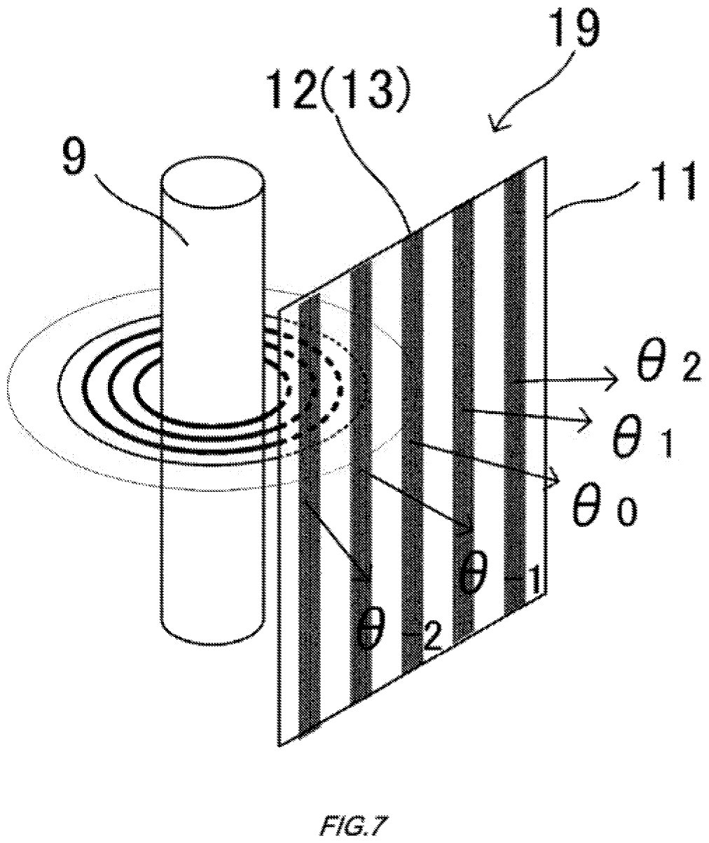

FIG. 7 shows a configuration of a thermal radiation lens 19 of a diffraction grating type utilizing the pattern arrays of the sheet-type material 10 according to the present embodiment. The thermal radiation lens 19 is configured in the same way as the sheet-type material 10 described earlier, except that the first pattern array 12 longitudinally extends and is arranged laterally periodically on one surface of the substrate 11, and corresponding to this, the second pattern array 13 is arranged on the back surface of the substrate 11 to overlap with the first pattern array 12. The refractive index of the thermal radiation lens 19 changes laterally periodically. If a heat source 9, such as a steelmaking slag, for example, is provided on the back surface side of the thermal radiation lens 19, thermal radiation released from the heat source 9 enters the thermal radiation lens 19 from the back surface side, and by its diffraction effect, the thermal radiation is released only toward a certain direction θ₀, θ_{±1}, and θ_{±2}. The thermal radiation lens 19 enables directional control of the thermal radiation.

Note that because, as described earlier, the real component Re (n_{eff}) of the effective refractive index of the sheet-type material 10 is increased as the meta-atoms 12a, 13a are densely arranged, and the real component Re (n_{eff}) is decreased as the meta-atoms 12a, 13a are sparsely arranged, a refractive index distribution may be provided on the substrate 11 by periodically changing the gap of the meta-atoms 12a, 13a in the lateral direction; periodically changing the radius of the meta-atoms 12a, 13a laterally arranged in line; or periodically changing the radius and the gap without changing an arrangement pitch of the meta-atoms 12a, 13a in the lateral direction, that is, by laterally arranging the meta-atoms 12a, 13a sparsely and densely periodically.

According to the analysis results of the optical properties of the above-mentioned pattern arrays for the designed frequency of 50 THz, shown in FIG. 2A to FIG. 2F, and for the designed frequency of 200 THz, shown in FIG. 4A to FIG. 4F, the meta-atoms 12a, 13a strongly depend on resonance conditions of non-polarizing thermal radiation, particularly the resonance conditions of the magnetic field, in the frequency band of the thermal radiation, and, therefore, the meta-atoms 12a, 13a may have a size and a shape having a width approximately 0.5 to 1.0 times of the half wavelength of the designed frequency for each of the X-axis direction and the Y-axis direction, or in any direction. Here, because the properties of the sheet-type material 10 for the thermal radiation depend on the dielectricity and magnetism of the material, it is proper to give the wavelength of the designed frequency by the effective wavelength in the substrate 11. Half of the effective wavelength (which is merely referred to as a wavelength, unless otherwise specified) may be employed as a half wavelength of the designed frequency to design the meta-atoms 12a, 13a.

In addition, because the thermal radiation is non-polarizing, a shape of the meta-atoms 12a, 13a is desirably a symmetrical shape in any direction, that is, a circle, which is not limiting, and the shape may be a square, a regular hexagon, a regular octagon, or the like symmetrical in a reference axis direction, such as the X-axis direction and the Y-axis direction. Because the orientation of these polygons may also be arbitrary, the width of the meta-atoms 12a, 13a in the X-axis direction and the width thereof in the Y-axis direction may be equivalent to each other within a range of at least the half wavelength of the thermal radiation (which may be the half of the effective wavelength in the substrate 11), and may be within a range of 0.8 to 1.2 of an optimum width, more preferably a range of 0.9 to 1.1 of the optimum width. In addition, the meta-atoms 12a, 13a may have a width in the X-axis direction and a width in the Y-axis direction not equivalent to each other as a circle or a square has, and if the difference between the width in the X-axis direction and the width in the Y-axis direction is sufficiently small relative to the half wavelength of the designed frequency, the meta-atoms 12a, 13a may have an asymmetrical shape in the X-axis direction and the Y-axis direction, such as an ellipse or a rectangular.

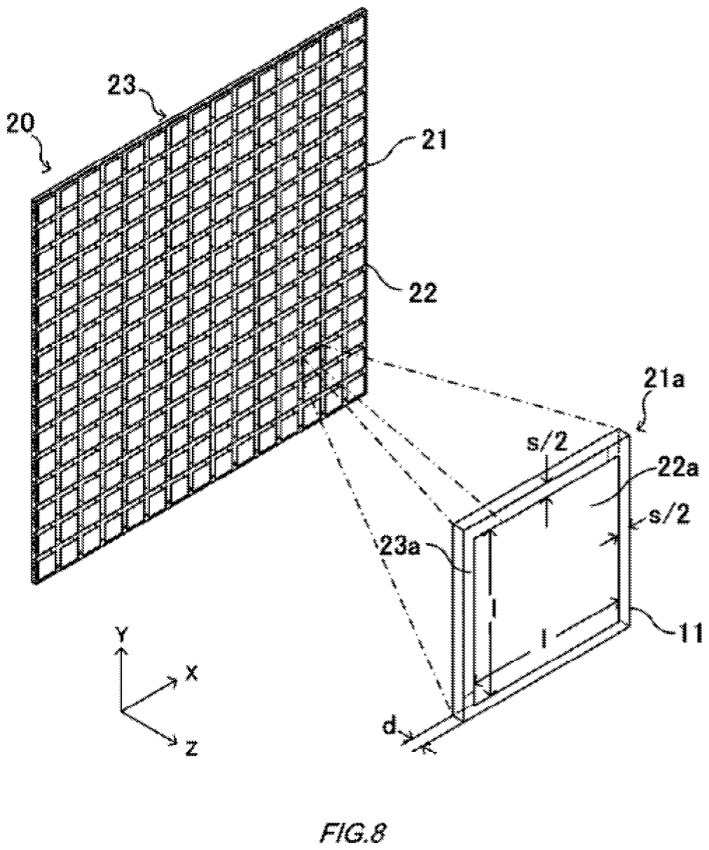

FIG. 8 shows a configuration of a sheet-type material 20 according to a first modification example and an enlarged drawing of a configuration of a unit cell 21a. Here, the unit cell 21a is a basic unit of the periodic structure of the sheet-type material 20. The sheet-type material 20 is a material capable of realizing the high refractive-index, non-reflective, and non-polarizing optical properties and includes a substrate 21, and first and second pattern arrays 22, 23.

The substrate 21 is configured in the same way as the substrate 11 of the sheet-type material 10 according to the embodiment described earlier.

The first and second pattern arrays 22, 23 are arranged in the same way as the first and second pattern arrays 12, 13 of the sheet-type material 10 according to the embodiment described earlier, except that meta-atoms 22a, 23a included in the first and second pattern arrays 22, 23 are formed in a square shape having one side of a length l and are arranged spaced regularly in the X-axis direction and the Y-axis direction, that is, arranged to be equally spaced in each direction, by providing a constant gap s (a square grid shape).

From an analysis, it is understood that, in the sheet-type material 20 having the first and second pattern arrays 22, 23 configured as such, a high refractive index, an ultralow reflectivity, and non-polarizing properties can be obtained in a thermal radiation region.

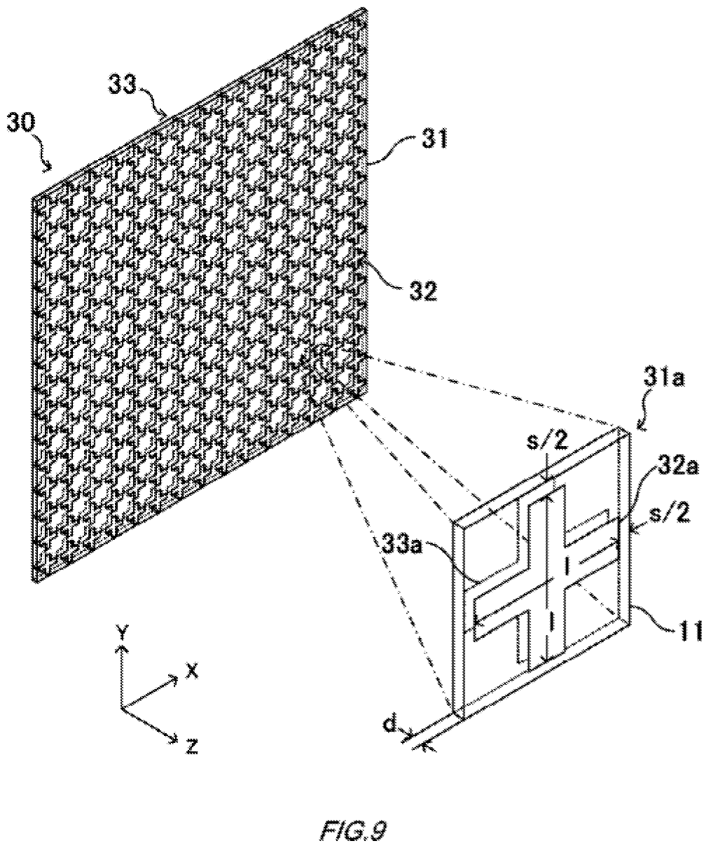

FIG. 9 shows a configuration of a sheet-type material 30 according to a second modification example and an enlarged drawing of a configuration of a unit cell 31a. Here, the unit cell 31a is a basic unit of the periodic structure of the sheet-type material 30. The sheet-type material 30 is a material capable of realizing the high refractive-index, non-reflective, and non-polarizing optical properties and includes a substrate 31 and first and second pattern arrays 32, 33.

The substrate 31 is configured in the same way as the substrate 11 of the sheet-type material 10 according to the embodiment described earlier.

The first and second pattern arrays 32, 33 are arranged in the same way as the first and second pattern arrays 12, 13 of the sheet-type material 10 according to the embodiment described earlier, except that meta-atoms 32a, 33a included in the first and second pattern arrays 32, 33 are formed in a cross shape having a length l and a width l and are arranged spaced regularly in the X-axis direction and the Y-axis direction, that is, arranged to be equally spaced in each direction by providing a constant gap s (a square grid shape).

From an analysis, it is understood that, in the sheet-type material 30 having the first and second pattern arrays 32, 33 configured as such, a high refractive index, an ultralow reflectivity, and non-polarizing properties can also be obtained in a thermal radiation region.

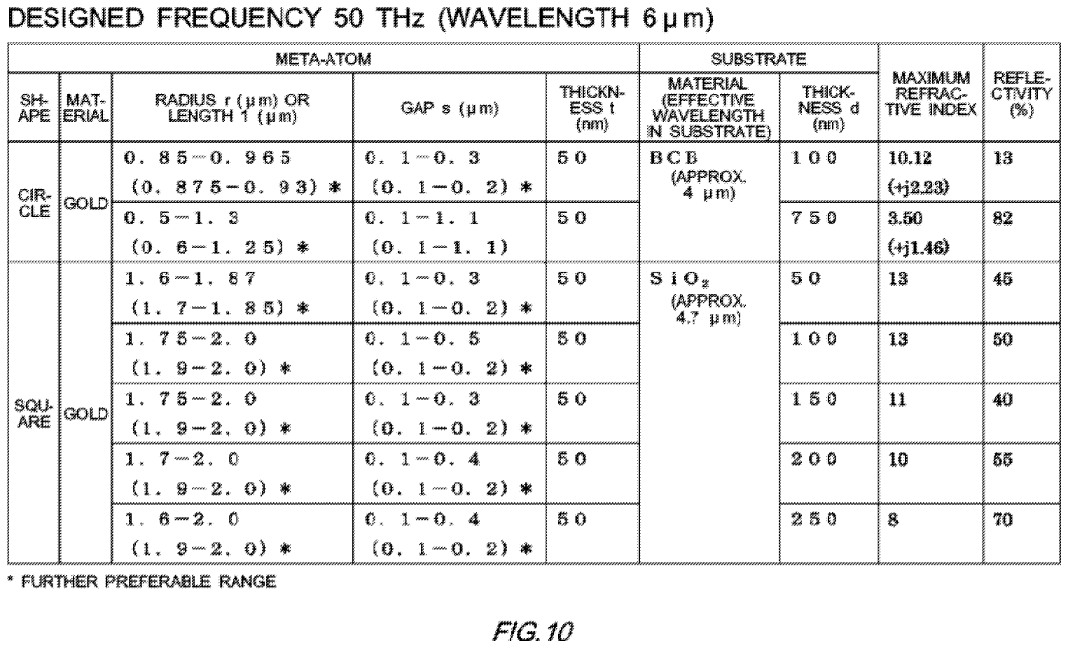

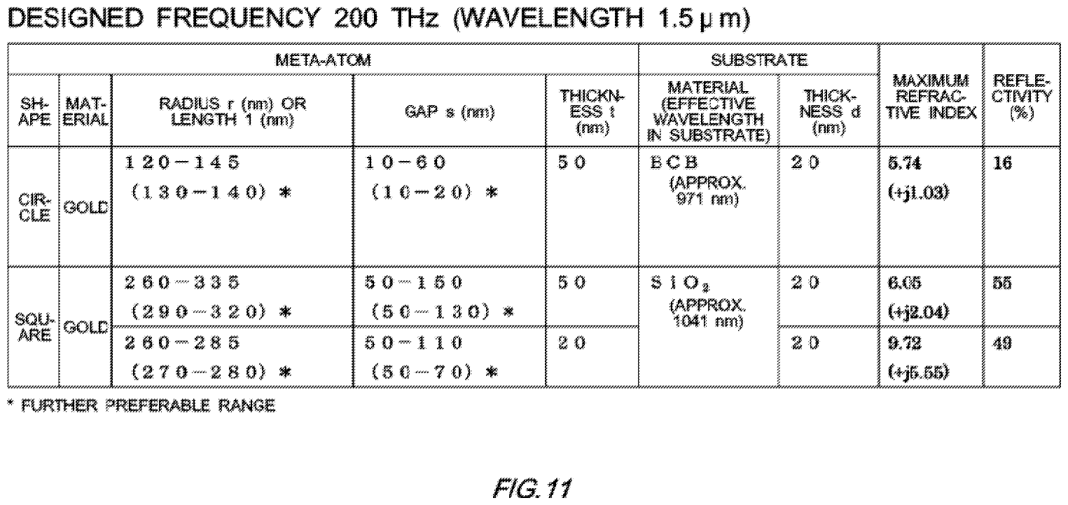

FIG. 10 and FIG. 11 show analysis results of optimum design conditions of sheet-type materials each for the designed frequency of 50 THz and the designed frequency of 200 THz. An optimum range (and a further preferable range) of the size (the radius r for a circular shape or a length l of one side for a square shape) of the meta-atom; a maximum refractive index; and a reflectivity, which are obtained from the analysis by the finite element method electromagnetic field simulator HFSS, are given for a material and a thickness d of the substrate, a shape and a material of the meta-atom, and a thickness t. It is understood that a high refractive index and non-polarizing properties can be obtained in the thermal radiation region under any condition.

As described above, the sheet-type material 10 according to the present embodiment includes the substrate 11, the first pattern array 12 arranged regularly in the X-axis direction and the Y-axis direction on one surface of the substrate 11, and the second pattern array 13 formed on the back surface, relative to the one surface, of the substrate 11 to overlap with the first pattern array 12, wherein the meta-atoms 12a, 13a included in the first and second pattern arrays 12, 13 have the same shape and the width in the X-axis direction and the width in the Y-axis direction equivalent to each other within a range of the half wavelength of the thermal radiation. In this manner, the sheet-type material 10 realizes the high refractive-index, non-reflective, and non-polarizing optical properties for a frequency band of the thermal radiation region (particularly 50 THz band and 200 THz band in the present embodiment). It becomes possible to configure the thermal radiation lens 18, 19 by utilizing the pattern arrays of the sheet-type material 10.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

9: heat source, 10, 20, 30: sheet-type material, 11, 21, 31: substrate, 11a, 21a, 31a: unit cell, 12, 13, 22, 23, 32, 33: first and second pattern arrays, 12a, 13a, 22a, 23a, 32a, 33a: meta-atom, 18, 19: thermal radiation lens

1. A thermal radiation lens configured to control propagation of thermal radiation, comprising:
a substrate;
a plurality of first patterns arranged, in a first region on one surface of the substrate, regularly in a first direction parallel to the one surface and in a second direction crossing the first direction; and
a plurality of second patterns formed, in a second region overlapping with the first region, on a back surface of the substrate, to overlap with each of the plurality of first patterns,
wherein, among the plurality of first patterns and the plurality of second patterns, a first pattern and a second pattern overlapping with each other with the substrate interposed therebetween have a same size and a same shape and have a width in the first direction and a width in the second direction equivalent to each other within a range of a half wavelength of the thermal radiation.

2. (canceled)

3. (canceled)

4. The thermal radiation lens according to claim 1, wherein
at least a portion of the plurality of first patterns and the plurality of second patterns is arranged with a gap interposed therebetween in the first direction and in the second direction, and
the plurality of first patterns and the plurality of second patterns have a circular shape, and for a frequency 200 THz of the thermal radiation, a radius of the circular shape is from 120 nm to 145 nm, and the gap is from 10 nm to 60 nm, and for a frequency 50 THz of the thermal radiation, a radius of the circular shape is from 0.5 μm to 1.3 μm, and the gap is from 0.1 μm to 1.1 μm.

5. The thermal radiation lens according to claim 1, wherein
at least a portion of the plurality of first patterns and the plurality of second patterns is arranged with a gap interposed therebetween in the first direction and in the second direction, and
the plurality of first patterns and the plurality of second patterns have a square shape, and for a frequency 200 THz of the thermal radiation, one side of the square shape is from 260 nm to 335 nm, and the gap is from 50 nm to 150 nm, and for a frequency 50 THz of the thermal radiation, one side of the square shape is from 1.6 nm to 2.0 μm, and the gap is from 0.1 nm to 0.5 μm.

6. The thermal radiation lens according to claim 4, wherein another portion of the plurality of first patterns and the plurality of second patterns is arranged adjacent to the at least the portion of the plurality of first patterns and the plurality of second patterns and arranged, in at least one of the first direction and the second direction, with another gap larger than the gap, interposed therebetween.

7. The thermal radiation lens according to claim 1, wherein another portion of the plurality of first patterns and the plurality of second patterns is disposed adjacent to at least a portion of the plurality of first patterns and the plurality of second patterns and has another width different from the width for at least one of the first direction and the second direction.

8. The thermal radiation lens according to claim 1, wherein the first region including the plurality of first patterns and the second region including the plurality of second patterns are arranged periodically in at least one axis direction parallel to the one surface.

9. The thermal radiation lens according to claim 1, wherein the substrate is a heat-tolerant dielectric film, and the plurality of first patterns and the plurality of second patterns are conductive metal films.

10. The thermal radiation lens according to claim 9, the substrate is formed of benzocyclobutene (BCB), polyimide, a quartz glass (SiO₂), or silicon nitride (Si₃N₄).

11. The thermal radiation lens according to claim 9, wherein the plurality of first patterns and the plurality of second patterns are formed of gold, silver, copper, or aluminum.

12. The thermal radiation lens according to claim 5, wherein another portion of the plurality of first patterns and the plurality of second patterns is arranged adjacent to the at least the portion of the plurality of first patterns and the plurality of second patterns and arranged, in at least one of the first direction and the second direction, with another gap larger than the gap, interposed therebetween.

13. The thermal radiation lens according to claim 4, wherein another portion of the plurality of first patterns and the plurality of second patterns is disposed adjacent to the at least the portion of the plurality of first patterns and the plurality of second patterns and has another width different from the width for at least one of the first direction and the second direction.

14. The thermal radiation lens according to claim 5, wherein another portion of the plurality of first patterns and the plurality of second patterns is disposed adjacent to the at least the portion of the plurality of first patterns and the plurality of second patterns and has another width different from the width for at least one of the first direction and the second direction.

15. The thermal radiation lens according to claim 6, wherein another portion of the plurality of first patterns and the plurality of second patterns is disposed adjacent to the at least the portion of the plurality of first patterns and the plurality of second patterns and has another width different from the width for at least one of the first direction and the second direction.

16. The thermal radiation lens according to claim 4, wherein the first region including the plurality of first patterns and the second region including the plurality of second patterns are arranged periodically in at least one axis direction parallel to the one surface.

17. The thermal radiation lens according to claim 5, wherein the first region including the plurality of first patterns and the second region including the plurality of second patterns are arranged periodically in at least one axis direction parallel to the one surface.

18. The thermal radiation lens according to claim 4, wherein the substrate is a heat-tolerant dielectric film, and the plurality of first patterns and the plurality of second patterns are conductive metal films.

19. The thermal radiation lens according to claim 5, wherein the substrate is a heat-tolerant dielectric film, and the plurality of first patterns and the plurality of second patterns are conductive metal films.

20. The thermal radiation lens according to claim 10, wherein the plurality of first patterns and the plurality of second patterns are formed of gold, silver, copper, or aluminum.
